(19) United States
(12) Patent Application Publication
(10) Pub. No.: US 2024/0294434 A1
(43) Pub. Date: Sep. 5, 2024

(54) METHODS AND COMPOSITIONS FOR LOW-CARBON CONCRETE PRODUCTION USING CARBON DIOXIDE AND SOLID WASTE STREAMS

(71) Applicant: CARBONBUILT, El Segundo, CA (US)

(72) Inventor: Iman MEHDIPOUR, Austin, TX (US)

(21) Appl. No.: 18/660,057

(22) Filed: May 9, 2024

Related U.S. Application Data
(63) Continuation of application No. PCT/US2022/050167, filed on Nov. 16, 2022.
(60) Provisional application No. 63/264,152, filed on Nov. 16, 2021.

(51) Int. Cl. C04B 28/14; C04B 18/162; C04B 22/06; C04B 40/02; C04B 111/10

(52) U.S. Cl. CPC C04B 28/14; C04B 18/162; C04B 22/064; C04B 40/0231; C04B 40/0263; C04B 2111/1087

(57) ABSTRACT

Set forth herein are methods for producing low-carbon concrete components comprising a cementitious mixture of industrial solid wastes such as coal combustion residues, lime, kiln dust, and gypsum. These cementitious mixtures are a substantial replacement for Portland cement-based concrete mixtures. The methods herein include mixing materials, pressing, and shaping the mixed materials into a structural concrete component, and exposing the structural component to carbon dioxide. The CO₂ may be sourced from CO₂ emission sources (e.g., waste CO₂-containing gas stream, dilute flue gas stream, a concentrated CO₂ gas stream, a commercially available CO₂ source, liquefied CO₂, or from the atmosphere) to harden and thereby form structural concrete components. In some examples, the finished concrete components (e.g., concrete block) are compliant with industry-standard requirements for use in construction applications and feature significantly lower carbon intensity compared to traditional cement-based concrete components.

### CROSS-REFERENCE TO RELATED APPLICATIONS

This application is a continuation of International Patent Application No. PCT/US2022/050167, filed Nov. 16, 2022, which claims priority to, and the benefit of, U.S. Provisional Patent Application No. 63/264,152, filed Nov. 16, 2021, the entire contents of both of which are herein incorporated by reference in their entirety for all purposes.

### BACKGROUND

Traditional concrete is a mixture of calcium silicate-dominant ordinary portland cement (“OPC”), mineral aggregates, water, and chemical additives. The reaction of OPC with water (hydration) forms calcium silicate hydrate (C—S—H) compounds. The precipitation of C—S—H between proximate particles induces cohesion/hardening. The result of this is porosity reduction and refinement that strengthens the concrete. Due to the significant impact of the construction industry on climate change, there is a pressing demand to implement OPC-alternative cementation solutions with significantly reduced embodied CO₂ intensities. Over 30 billion metric tons of concrete are produced per year, involving the production of over 4.5 billion metric tons of cement, with CO₂ emissions intensity on the order of 0.8-0.9 kg CO₂/kg cement. Emissions associated with cement production make up over 5% of global CO₂ emissions, contributing significantly to global climate change.

The use of industrial solid wastes, such as fly ash and slag, as a partial replacement for cement in traditional cement-based concrete is limited. U.S. Pat. Nos. 4,018,617 and 4,101,332, disclose using mixtures of fly ash, cement kiln dust, and aggregate for creating a stabilized base-supporting surface. This base-supporting surface was used to replace conventional gravel or asphalt aggregate stabilized bases in road construction. U.S. Pat. Nos. 4,018,617 and 4,101,332, disclose ranges of fly ash in cement mixtures, such as 6-24% by weight, cement kiln dust (CKD) at 4-16% by weight, and aggregate a 60-90% by weight. See also U.S. Pat. No. 4,038,095 which discloses cement mixtures that include about 10-14% by weight fly ash, and about 5-15% by weight lime kiln dust with the balance of the mixture being aggregate in the range of 71-85% by weight. See also U.S. Pat. No. 4,407,677, which discloses the manufacture of concrete products, such as blocks or bricks. U.S. Pat. No. 4,407,677 discloses fly ash in combination with portland cement; and that this combination could be replaced in its entirety by CKD with modest improvement in early compressive strength values for such products. See also U.S. Pat. No. 6,645,290, which discloses settable compositions for general purpose concrete construction containing Class-F fly ash (FFA), Class-C fly ash (CFA), slag, or cement kiln dust.

What is needed in the field to which the instant disclosure pertains are more sustainable concrete mixtures which include industrial solid wastes, and which minimize the use of calcined materials comprising calcium silicate dominant minerals such as ordinary portland cement (OPC). What is needed in the field to which the instant disclosure pertains are methods of using CO₂ gas streams to harden concrete via concurrent hydration and carbonation reactions. Set forth herein are solutions to these challenges as well as other challenges in the field to which the instant invention pertains.

### BRIEF SUMMARY OF THE INVENTION

In some embodiments, set forth herein is a process of producing a concrete component, including: forming, or having formed, a cementitious mixture including industrial solid wastes; shaping, or having shaped, the cementitious mixture into a structural component; and exposing, or having exposed, the structural component to CO₂ and H₂O; wherein the cementitious mixture includes: gypsum at about 0.5% to about 5% by weight (w/w), and an aluminosilicate material; wherein the cementitious mixture has a sulfate-to-alumina [SO₃/Al₂O₃] ratio by mass of 0.05≤[SO₃/Al₂O₃]≤3.

In some embodiments, set forth herein, here is A process of producing a concrete component, comprising: forming, or having formed, a cementitious mixture comprising industrial solid wastes; shaping, or having shaped, the cementitious mixture into a structural component; and exposing, or having exposed, the structural component to CO₂ and H₂O; wherein the cementitious mixture comprises: gypsum, an aluminosilicate material, and an alkaline material; wherein the cementitious mixture has:

a sulfate-to-alumina [SO₃/Al₂O₃] ratio by mass of 0.05≤[SO₃/Al₂O₃]≤3; and

calcium hydroxide to aluminosilicate ratio by mass of 0.01 to 1.

In some embodiments, set forth herein is a concrete component made by a process herein.

In some embodiments, set forth herein is a concrete including a concrete component herein.

In some embodiments, set forth herein is a shaped green body including a cementitious mixture of an aluminosilicate material and gypsum, wherein the gypsum is present in a range of about 0.5% to about 5% by weight (w/w).

In some embodiments, set forth herein is a cementitious mixture that includes gypsum at about 0.5% to about 5% by weight (w/w), and an aluminosilicate material; wherein the cementitious mixture has a sulfate-to-alumina [SO₃/Al₂O₃] ratio by mass of 0.05≤[SO₃/Al₂O₃]≤3. In some examples, the cementitious mixture consists, or consists essentially of gypsum at about 0.5% to about 5% by weight (w/w) and an aluminosilicate material. In certain examples, the aluminosilicate material is kiln dust, lime kiln dust, or cement kiln dust. In certain examples, the aluminosilicate material is coal combustion such as fly ashes, ponded ashes, landfilled ashes, and bottom ashes, biomass ashes, fluidized bed combustion ashes, circulating fluidized bed ashes residues. In some examples, the cementitious mixture comprises gypsum, an aluminosilicate material, and an industrial alkaline solid waste such as lime kiln dust, or cement kiln dust to enhance CO₂ uptake and carbonation strengthening.

### BRIEF DESCRIPTION OF THE FIGURES

FIG. 1 shows CO₂ uptake of different solid particulates following exposure to 12 vol. % CO₂ gas streams at a temperature (T)=40-50° C. and a relative humidity (RH)=40%-80%.

FIG. 2(a) shows the effect of gypsum content on CO₂ uptake of concrete mixture comprising aluminosilicate and gypsum minerals.

FIG. 2(b) shows the effect of gypsum content on compressive strength of concrete mixture comprising aluminosilicate and gypsum minerals.

FIG. 3(a) shows the effect of gypsum content on CO₂ uptake by concrete mixture comprising calcium silicate-dominant (cement) and gypsum minerals.

FIG. 3(b) shows the effect of gypsum content on compressive strength of concrete mixture comprising calcium silicate-dominant (cement) and gypsum minerals.

FIG. 4(a) shows thermogravimetric profiles that show the effect of gypsum addition on ettringite and calcium carbonate formation and retransformation of phases as a function of time for aluminosilicate mixtures following post-hydration curing.

FIG. 4(b) shows thermogravimetric profiles that show the effect of gypsum addition on ettringite and calcium carbonate formation and retransformation of phases as a function of time for aluminosilicate mixtures following carbonation curing.

FIG. 4(c) shows thermogravimetric profiles that show the effect of gypsum addition on ettringite and calcium carbonate formation and retransformation of phases as a function of time for aluminosilicate mixtures following post-hydration after carbonation curing.

### DETAILED DESCRIPTION OF THE INVENTION

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. Unless specified otherwise, “about” means 10% of the qualified numerical value, and all values within. For example, about 50° C., includes 45° C., 46° C., 47° C., 48° C., 49° C., 50° C., 51° C., 52° C., 53° C., 54° C., and 55° C.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

As used herein, “virgin portlandite,” refers to portlandite (e.g., Ca(OH)₂)) which has not reacted with H₂O or CO₂.

As used herein, “alkaline mineral materials” refers to materials which include Ca and/or Mg and which are used in industrial processes. Alkaline-rich mineral materials include, but are not limited to, Ca(OH)₂, lime kiln dust, lime, hydrated lime, cement kiln dust, calcium-rich coal combustion residues, mineral sorbent/scrubbing residues comprising anhydrous CaO and/or Ca(OH)₂, and combinations thereof. The alkaline mineral materials may further comprise at least one of oxides, hydroxides, carbonates, silicates, sulfites, sulfates, chlorides, nitrates, or nitrites of calcium and/or magnesium, or any combination thereof.

Herein, a “residue” is an alkaline-rich mineral material which has been already contacted with CO₂-containing gas stream, for example, as a sorbent or scrubber in a CO₂-flue gas. An alkaline-rich residue may include hydrated lime, lime kiln dust, off-spec limes, mineral sorbent/scrubbing residues, or a combination thereof. A residue may be referred to in the art as a mineral sorbent.

As used herein, the phrase “concentrated vapor containing CO₂,” refers to a gaseous stream that has a higher concentration of CO₂ than air does. The concentrated vapor containing CO₂ may include air, as well as the individual components of air, such as, but not limited to, N₂, O₂, water, and combinations thereof. In some examples, the concentrated vapor containing CO₂ is processed so it has a particular relative humidity, a particular temperature, a particular flow rate, or a combination thereof. In some examples, the concentrated vapor is processed so it has a particular CO₂ concentration. This may be accomplished using fractional enrichment processes that progressively increase the concentration of CO₂ in a gas that already has higher concentration of CO₂ than air does.

As used herein, a “concrete product,” refers to the product resulting from the carbonation, and optionally the hydration, of a concrete component.

As used herein, a “concrete component,” refers to concrete which may be shaped or pressed in a particular form, e.g., an I-beam, a masonry block, or a flat sheet. The fresh (i.e., unreacted) concrete may include portlandite (Ca(OH)₂) and is capable of reacting with CO₂ to form concrete.

As used herein, “aluminosilicate mineral materials” refers to materials which include silica and/or alumina in the form of amorphous or crystalline or combination thereof. Alkaline-rich mineral materials include, but are not limited to, coal combustion residues, slag, off-spec fly ashes, biomass ashes, fluidized bed combustion ashes, circulating fluidized bed ashes, calcium rich fly ashes, calcium-poor fly ashes, ponded ashes, landfilled ashes, bottom ashes, flue gas ashes, and combinations thereof. The aluminosilicate mineral materials may further comprise at least one of oxides, hydroxides, carbonates, silicates, sulfites, sulfates, chlorides, nitrates, or nitrites of calcium and/or magnesium, or any combination thereof.

Herein, the word “method” is used interchangeably with the word “process.”

### Processes for Forming Concrete Products and Cementitious Mixtures

In some examples, including any of the foregoing, set forth herein is a method of forming concrete products comprising a cementitious mixture, wherein the cementitious mixture comprises industrial solid waste materials and CO₂-containing gas streams. In some examples, the cementitious mixtures comprise aluminosilicate industrial solid wastes (e.g., coal combustion residues or slag), lime (e.g., quick lime or hydrated lime), kiln dust (e.g., lime kiln dust or cement kiln dust), and gypsum (e.g., flue gas desulfurization gypsum). In some examples, the manufacturing process comprises mixing cementitious materials, aggregates, and water to make concrete, then shaping and pressing the concrete into concrete components, and exposing the concrete components to CO₂ gas streams to harden via hydration and carbonation reaction. In some examples, this produces structural concrete components.

In some examples, including any of the foregoing, the methods herein include concurrent hydration and carbonation reactions that result in hardening and microstructural densification. In certain examples, the hydration and carbonation reactions include (i) hydraulic reactions of calcium silicate phases of coal combustion residues and kiln dust, (ii) pozzolanic reactions among coal combustion residues, kiln dust, and lime, (iii) ettringite formation resulting from coal combustion residues and gypsum reaction, (iv) carboaluminate formation resulting from coal combustion residues and kiln dust reaction, and finally (v) carbonate mineral formation resulting from carbonation reactions of coal combustion residues, kiln dust, lime, and ettringite when exposed to CO₂ gas stream.

In some examples, including any of the foregoing, the methods herein include using hydraulic and pozzolanic cementitious materials (e.g., coal combustion residues, slag, kiln dust) in hydration reactions. In some examples, including any of the foregoing, the methods herein include using alkaline materials (e.g., coal combustion residues, slag, kiln dust, lime) and hydration products (e.g., C—S—H, Ca(OH)₂, and ettringite) in carbonation reactions. In some examples, including any of the foregoing, the methods herein include using both hydration and carbonation reactions to contribute to the strength gain of the concrete components.

In some examples, including any of the foregoing, the methods herein include controlling the level of strengthening of cementitious mixtures by the degree of hydration and carbonation. In certain examples, the mineral carbonation of cementitious is the dominant contribution to microstructure densification and strength development. The degree of carbonation is expressed as CO₂ uptake (quantified as a mass of CO₂ sequestered in solid products per mass of initial solid material) that describes the material's efficiency in sequestering gaseous CO₂ into stable carbonate minerals. The CO₂ uptake is quantified using thermal analysis measurements such as thermogravimetric analysis (TGA).

In some examples, including any of the foregoing, the cementitious mixture comprises coal combustion residues, slag, kiln dust, and lime have an average particle size in a range of about 500 μm to about 100 nm. Particle size herein is measured using a particle size analyzer such as static light scattering (SLS). In certain examples, the particle size is characterized by a D₅ of 1.2 μm. In certain examples, the particle size is characterized by a D₅₀ of 18 μm. In certain examples, the particle size is characterized by a D₉₅ of 67 μm. In some examples, the average particle size is in a range of about 1 μm to about 500 μm. In some examples, the average particle size is in a range of about 10 μm to about 500 μm. In some examples, the average particle size is in a range of about 100 μm to about 500 μm. In some examples, the average particle size is in a range of about 1 μm to about 250 μm. In some examples, the average particle size is in a range of about 1 μm to about 100 μm. In some examples, the average particle size is in a range of about 1 μm to about 10 μm. In some examples, the average particle size is in a range of about 1 μm to about 50 μm. In some examples, the average particle size is in a range of about 1 μm to about 150 μm. In some examples, the average particle size is in a range of about 1 μm to about 200 μm. In some examples, the average particle size is in a range of about 100 μm to about 200 μm. In some examples, the average particle size is in a range of about 100 μm to about 300 μm. In some examples, the average particle size is in a range of about 100 μm to about 400 μm. In some examples, the average particle size is in a range of about 100 μm to about 500 μm. In some examples, the average particle size is in a range of about 200 μm to about 500 μm. In some examples, the average particle size is in a range of about 300 μm to about 500 μm. In some examples, the average particle size is in a range of about 400 μm to about 500 μm.

In some examples, including any of the foregoing, the methods herein include compacting the cementitious mixture to form the structural component. For example, in some embodiments, shaping the cementitious mixture includes either compacting the cementitious mixture (dry-casting) or pouring the mixture into a mold (wet-casting) to form the structural component. In some embodiments, compacting the cementitious mixture is performed at a pressure in a range of about 0.5 MPa to about 35 MPa. In some of these examples, the pressure is 35 Mpa. In some other examples, the pressure is 30 MPa. In some of these examples, the pressure is 25 Mpa. In some other examples, the pressure is 20 MPa. In some of these examples, the pressure is 15 Mpa. In some other examples, the pressure is 10 MPa. In some of these examples, the pressure is 5 Mpa. In some other examples, the pressure is 4 MPa. In some of these examples, the pressure is 3 Mpa. In some other examples, the pressure is 2 MPa. In some of these examples, the pressure is 1 Mpa. In some other examples, the pressure is 0.5 MPa.

In some examples, including any of the foregoing, the cementitious mixture comprises aluminosilicate industrial solid wastes in a range of from about 5% to 20% of the total solid mass of the concrete mixture. Some examples of industrial solid wastes include coal combustion residues (e.g., class C fly ash, class F fly ashes) and slag (e.g., basic oxygen furnace slag, electric arc furnace slag, ladle slag, or blast furnace slag). The term coal combustion residue has its typical meaning in the art. Coal combustion residuals can include coal ash and can include components such as those residuals produced when coal is burned by power plants. In some examples, the cementitious mixture includes 5% (w/w) industrial solid wastes relative to the total solid mass of the concrete mixture. In some examples, the cementitious mixture includes 6% (w/w) industrial solid wastes relative to the total solid mass of the concrete mixture. In some examples, the cementitious mixture includes 7% (w/w) industrial solid wastes relative to the total solid mass of the concrete mixture. In some examples, the cementitious mixture includes 8% (w/w) industrial solid wastes relative to the total solid mass of the concrete mixture. In some examples, the cementitious mixture includes 9% (w/w) industrial solid wastes relative to the total solid mass of the concrete mixture. In some examples, the cementitious mixture includes 10% (w/w) industrial solid wastes relative to the total solid mass of the concrete mixture. In some examples, the cementitious mixture includes 11% (w/w) industrial solid wastes relative to the total solid mass of the concrete mixture. In some examples, the cementitious mixture includes 12% (w/w) industrial solid wastes relative to the total solid mass of the concrete mixture. In some examples, the cementitious mixture includes 13% (w/w) industrial solid wastes relative to the total solid mass of the concrete mixture. In some examples, the cementitious mixture includes 14% (w/w) industrial solid wastes relative to the total solid mass of the concrete mixture. In some examples, the cementitious mixture includes 15% (w/w) industrial solid wastes relative to the total solid mass of the concrete mixture. In some examples, the cementitious mixture includes 16% (w/w) industrial solid wastes relative to the total solid mass of the concrete mixture. In some examples, the cementitious mixture includes 17% (w/w) industrial solid wastes relative to the total solid mass of the concrete mixture. In some examples, the cementitious mixture includes 18% (w/w) industrial solid wastes relative to the total solid mass of the concrete mixture. In some examples, the cementitious mixture includes 19% (w/w) industrial solid wastes relative to the total solid mass of the concrete mixture. In some examples, the cementitious mixture includes 20% (w/w) industrial solid wastes relative to the total solid mass of the concrete mixture.

In some examples, including any of the foregoing, the cementitious mixture comprises kiln dust in a range of from about 1% to 20% of the total solid mass of the concrete mixture. Examples of kiln dust that can be used are lime kiln dust that is sourced from the lime manufacturing process or cement kiln dust that is sourced from the cement manufacturing process. In some examples, the cementitious mixture includes 1% (w/w) kiln dust relative to the total solid mass of the concrete mixture. In some examples, the cementitious mixture includes 2% (w/w) kiln dust relative to the total solid mass of the concrete mixture. In some examples, the cementitious mixture includes 3% (w/w) kiln dust relative to the total solid mass of the concrete mixture. In some examples, the cementitious mixture includes 4% (w/w) kiln dust relative to the total solid mass of the concrete mixture. In some examples, the cementitious mixture includes 5% (w/w) kiln dust relative to the total solid mass of the concrete mixture. In some examples, the cementitious mixture includes 6% (w/w) kiln dust relative to the total solid mass of the concrete mixture. In some examples, the cementitious mixture includes 7% (w/w) kiln dust relative to the total solid mass of the concrete mixture. In some examples, the cementitious mixture includes 8% (w/w) kiln dust relative to the total solid mass of the concrete mixture. In some examples, the cementitious mixture includes 9% (w/w) kiln dust relative to the total solid mass of the concrete mixture. In some examples, the cementitious mixture includes 10% (w/w) kiln dust relative to the total solid mass of the concrete mixture. In some examples, the cementitious mixture includes 11% (w/w) kiln dust relative to the total solid mass of the concrete mixture. In some examples, the cementitious mixture includes 12% (w/w) kiln dust relative to the total solid mass of the concrete mixture. In some examples, the cementitious mixture includes 13% (w/w) kiln dust relative to the total solid mass of the concrete mixture. In some examples, the cementitious mixture includes 14% (w/w) kiln dust relative to the total solid mass of the concrete mixture. In some examples, the cementitious mixture includes 15% (w/w) kiln dust relative to the total solid mass of the concrete mixture. In some examples, the cementitious mixture includes 16% (w/w) kiln dust relative to the total solid mass of the concrete mixture. In some examples, the cementitious mixture includes 17% (w/w) kiln dust relative to the total solid mass of the concrete mixture. In some examples, the cementitious mixture includes 18% (w/w) kiln dust relative to the total solid mass of the concrete mixture. In some examples, the cementitious mixture includes 19% (w/w) kiln dust relative to the total solid mass of the concrete mixture. In some examples, the cementitious mixture includes 20% (w/w) kiln dust relative to the total solid mass of the concrete mixture.

In some examples, including any of the foregoing, the cementitious mixture comprises virgin quick lime (CaO), virgin hydrated lime (also known as portlandite), or hydrated lime residue in a range of from about 0.5% to about 10% of the total solid mass of the concrete mixture. In some embodiments, the hydrated lime residue is obtained by contacting hydrated lime with a carbon dioxide-containing gas stream (e.g., a flue gas) via scrubbing or sorbent injection (dry or semi-wet) methods. In some embodiments, the mineral sorbent residue is obtained by contacting hydrated lime with an atmospheric carbon dioxide source. In some examples, the cementitious mixture includes 0.5% (w/w) virgin quick lime (CaO), virgin hydrated lime (also known as portlandite), or portlandite residue relative to the total solid mass of the concrete mixture. In some examples, the cementitious mixture includes 1% (w/w) virgin quick lime (CaO), virgin hydrated lime (also known as portlandite), or portlandite residue relative to the total solid mass of the concrete mixture. In some examples, the cementitious mixture includes 2% (w/w) virgin quick lime (CaO), virgin hydrated lime (also known as portlandite), or portlandite residue relative to the total solid mass of the concrete mixture. In some examples, the cementitious mixture includes 3% (w/w) virgin quick lime (CaO), virgin hydrated lime (also known as portlandite), or portlandite residue relative to the total solid mass of the concrete mixture. In some examples, the cementitious mixture includes 4% (w/w) virgin quick lime (CaO), virgin hydrated lime (also known as portlandite), or portlandite residue relative to the total solid mass of the concrete mixture. In some examples, the cementitious mixture includes 5% (w/w) virgin quick lime (CaO), virgin hydrated lime (also known as portlandite), or portlandite residue relative to the total solid mass of the concrete mixture. In some examples, the cementitious mixture includes 6% (w/w) virgin quick lime (CaO), virgin hydrated lime (also known as portlandite), or portlandite residue relative to the total solid mass of the concrete mixture. In some examples, the cementitious mixture includes 7% (w/w) virgin quick lime (CaO), virgin hydrated lime (also known as portlandite), or portlandite residue relative to the total solid mass of the concrete mixture. In some examples, the cementitious mixture includes 8% (w/w) virgin quick lime (CaO), virgin hydrated lime (also known as portlandite), or portlandite residue relative to the total solid mass of the concrete mixture. In some examples, the cementitious mixture includes 9% (w/w) virgin quick lime (CaO), virgin hydrated lime (also known as portlandite), or portlandite residue relative to the total solid mass of the concrete mixture. In some examples, the cementitious mixture includes 10% (w/w) virgin quick lime (CaO), virgin hydrated lime (also known as portlandite), or portlandite residue relative to the total solid mass of the concrete mixture.

In some examples, including any of the foregoing, the cementitious mixture comprises natural gypsum or synthetic gypsum in a range of about 0.5% to about 5%. Natural gypsum is mined or quarried from the earth and ground into a powder. Synthetic gypsum is collected from environmental control systems that are installed in the stacks of coal-fired power plants. These systems capture particles and gases including sulfur dioxide. The sulfur dioxide is reacted with limestone and water to become synthetic or flue-gas desulfurization (FGD) gypsum. In some examples, the cementitious mixture includes 0.5% (w/w) natural gypsum or synthetic gypsum relative to the total solid mass of the concrete mixture. In some examples, the cementitious mixture includes 1% (w/w) natural gypsum or synthetic gypsum relative to the total solid mass of the concrete mixture. In some examples, the cementitious mixture includes 2% (w/w) natural gypsum or synthetic gypsum relative to the total solid mass of the concrete mixture. In some examples, the cementitious mixture includes 3% (w/w) natural gypsum or synthetic gypsum relative to the total solid mass of the concrete mixture. In some examples, the cementitious mixture includes 4% (w/w) natural gypsum or synthetic gypsum relative to the total solid mass of the concrete mixture. In some examples, the cementitious mixture includes 5% (w/w) natural gypsum or synthetic gypsum relative to the total solid mass of the concrete mixture.

In some examples, including any of the foregoing, the cementitious mixture comprises hydraulic cementitious materials such as portland cement or granulated blast furnace slag in the range of about 0% to about 5% of the total solid mass of the concrete mixture. In some examples, the cementitious mixture includes 1% (w/w) hydraulic cementitious materials relative to the total solid mass of the concrete mixture. In some examples, the cementitious mixture includes 2% (w/w) hydraulic cementitious materials relative to the total solid mass of the concrete mixture. In some examples, the cementitious mixture includes 3% (w/w) hydraulic cementitious materials relative to the total solid mass of the concrete mixture. In some examples, the cementitious mixture includes 4% (w/w) hydraulic cementitious materials relative to the total solid mass of the concrete mixture. In some examples, the cementitious mixture includes 5% (w/w) hydraulic cementitious materials relative to the total solid mass of the concrete mixture.

In some examples, including any of the foregoing, the CO₂ gas source is effluent from an industrial CO₂-containing gas stream, dilute flue gas stream, a concentrated CO₂ gas stream, a commercially available CO₂ source, liquefied CO₂, or from the atmosphere. In some examples, the CO₂ gas source is effluent from an industrial CO₂-containing gas stream. In some examples, the CO₂ gas source is effluent from a concentration CO₂ gas stream. In some examples, the CO₂ gas source is effluent from a commercially available CO₂ source. In some examples, the CO₂ gas source is effluent from liquefied CO₂. In some examples, the CO₂ gas source is effluent from the atmosphere. In some examples, the CO₂ gas source is effluent from a combination of an industrial CO₂-containing gas stream, dilute flue gas stream, a concentrated CO₂ gas stream, a commercially available CO₂ source, liquefied CO₂, or from the atmosphere. In some examples, CO₂ gas source is effluent from dilute post-combustion or post-calcination flue gas streams.

In some examples, including any of the foregoing, either dilute (2%<<90% (v/v)) or rich CO₂ (>90% (v/v)) concentration streams are used for carbonation curing process. In some examples, the concentrated gas stream comprises about 2-99% (v/v) CO₂. In some embodiments, the CO₂ gas stream comprises greater than or equal to 2% (v/v) CO₂. In some embodiments, the CO₂ gas stream comprises greater than or equal to 3% (v/v) CO₂. In some embodiments, the CO₂ gas stream comprises greater than or equal to 4% (v/v) CO₂. In some embodiments, the CO₂ gas stream comprises greater than or equal to 5% (v/v) CO₂. In some embodiments, the CO₂ gas stream comprises greater than or equal to 6% (v/v) CO₂. In some embodiments, the CO₂ gas stream comprises greater than or equal to 7% (v/v) CO₂. In some embodiments, the CO₂ gas stream comprises greater than or equal to 8% (v/v) CO₂. In some embodiments, the CO₂ gas stream comprises greater than or equal to 9% (v/v) CO₂. In some embodiments, the CO₂ gas stream comprises greater than or equal to 10% (v/v) CO₂. In some embodiments, the CO₂ gas stream comprises greater than or equal to 15% (v/v) CO₂. In some embodiments, the CO₂ gas stream comprises greater than or equal to 20% (v/v) CO₂. In some embodiments, the CO₂ gas stream comprises greater than or equal to 25% (v/v) CO₂. In some embodiments, the CO₂ gas stream comprises greater than or equal to 30% (v/v) CO₂. In some embodiments, the CO₂ gas stream comprises greater than or equal to 35% (v/v) CO₂. In some embodiments, the CO₂ gas stream comprises greater than or equal to 40% (v/v) CO₂. In some embodiments, the CO₂ gas stream comprises greater than or equal to 45% (v/v) CO₂. In some embodiments, the CO₂ gas stream comprises greater than or equal to 50% (v/v) CO₂. In some embodiments, the CO₂ gas stream comprises greater than or equal to 55% (v/v) CO₂. In some embodiments, the CO₂ gas stream comprises greater than or equal to 60% (v/v) CO₂. In some embodiments, the CO₂ gas stream comprises greater than or equal to 65% (v/v) CO₂. In some embodiments, the CO₂ gas stream comprises greater than or equal to 70% (v/v) CO₂. In some embodiments, the CO₂ gas stream comprises greater than or equal to 75% (v/v) CO₂. In some embodiments, the CO₂ gas stream comprises greater than or equal to 80% (v/v) CO₂. In some embodiments, the CO₂ gas stream comprises greater than or equal to 85% (v/v) CO₂. In some embodiments, the CO₂ gas stream comprises greater than or equal to 90% (v/v) CO₂. In some embodiments, the CO₂ gas stream comprises greater than or equal to 95% (v/v) CO₂. In some embodiments, the CO₂ gas stream comprises greater than or equal to 99% (v/v) CO₂.

In some examples, including any of the foregoing, the CO₂ gas stream passes through a gas processing unit, in which the temperature, relative humidity, and/or flow rate of the CO₂ gas stream is adjusted. In some embodiments, the temperature of the CO₂ gas stream may be adjusted to be in a range of about 15° C. to about 100° C. In some embodiments, the relative humidity of the CO₂ gas stream may be adjusted to be in a range of about 0% to about 95%. In some embodiments, the flow rate of the CO₂ gas stream may be adjusted to be in a range of about 1 SCFM to about 10,000 SCFM. In some embodiments, the temperature of the CO₂ gas stream is adjusted to 15° C. In some embodiments, the temperature of the CO₂ gas stream is adjusted to 20° C. In some embodiments, the temperature of the CO₂ gas stream is adjusted to 25° C. In some embodiments, the temperature of the CO₂ gas stream is adjusted to 30° C. In some embodiments, the temperature of the CO₂ gas stream is adjusted to 35° C. In some embodiments, the temperature of the CO₂ gas stream is adjusted to 40° C. In some embodiments, the temperature of the CO₂ gas stream is adjusted to 45° C. In some embodiments, the temperature of the CO₂ gas stream is adjusted to 50° C. In some embodiments, the temperature of the CO₂ gas stream is adjusted to 55° C. In some embodiments, the temperature of the CO₂ gas stream is adjusted to 60° C. In some embodiments, the temperature of the CO₂ gas stream is adjusted to 65° C. In some embodiments, the temperature of the CO₂ gas stream is adjusted to 70° C. In some embodiments, the temperature of the CO₂ gas stream is adjusted to 75° C. In some embodiments, the temperature of the CO₂ gas stream is adjusted to 80° C. In some embodiments, the temperature of the CO₂ gas stream is adjusted to 85° C. In some embodiments, the temperature of the CO₂ gas stream is adjusted to 90° C. In some embodiments, the temperature of the CO₂ gas stream is adjusted to 95° C. In some embodiments, the temperature of the CO₂ gas stream is adjusted to 100° C. In some embodiments, the relative humidity of the CO₂ gas stream is adjusted to 0%. In some embodiments, the relative humidity of the CO₂ gas stream is adjusted to 10%. In some embodiments, the relative humidity of the CO₂ gas stream is adjusted to 20%. In some embodiments, the relative humidity of the CO₂ gas stream is adjusted to 30%. In some embodiments, the relative humidity of the CO₂ gas stream is adjusted to 40%. In some embodiments, the relative humidity of the CO₂ gas stream is adjusted to 50%. In some embodiments, the relative humidity of the CO₂ gas stream is adjusted to 60%. In some embodiments, the relative humidity of the CO₂ gas stream is adjusted to 70%. In some embodiments, the relative humidity of the CO₂ gas stream is adjusted to 80%. In some embodiments, the relative humidity of the CO₂ gas stream is adjusted to 90%. In some embodiments, the relative humidity of the CO₂ gas stream is adjusted to 100%. In some embodiments, the flow rate of the CO₂ gas stream is adjusted to 1 SCFM. In some embodiments, the flow rate of the CO₂ gas stream is adjusted to 10 SCFM. In some embodiments, the flow rate of the CO₂ gas stream is adjusted to 100 SCFM. In some embodiments, the flow rate of the CO₂ gas stream is adjusted to 200 SCFM. In some embodiments, the flow rate of the CO₂ gas stream is adjusted to 300 SCFM. In some embodiments, the flow rate of the CO₂ gas stream is adjusted to 400 SCFM. In some embodiments, the flow rate of the CO₂ gas stream is adjusted to 500 SCFM. In some embodiments, the flow rate of the CO₂ gas stream is adjusted to 600 SCFM. In some embodiments, the flow rate of the CO₂ gas stream is adjusted to 70 SCFM. In some embodiments, the flow rate of the CO₂ gas stream is adjusted to 800 SCFM. In some embodiments, the flow rate of the CO₂ gas stream is adjusted to 900 SCFM. In some embodiments, the flow rate of the CO₂ gas stream is adjusted to 1,000 SCFM. In some embodiments, the flow rate of the CO₂ gas stream is adjusted to 2,000 SCFM. In some embodiments, the flow rate of the CO₂ gas stream is adjusted to 3,000 SCFM. In some embodiments, the flow rate of the CO₂ gas stream is adjusted to 4,000 SCFM. In some embodiments, the flow rate of the CO₂ gas stream is adjusted to 5,000 SCFM. In some embodiments, the flow rate of the CO₂ gas stream is adjusted to 6,000 SCFM. In some embodiments, the flow rate of the CO₂ gas stream is adjusted to 7,000 SCFM. In some embodiments, the flow rate of the CO₂ gas stream is adjusted to 8,000 SCFM. In some embodiments, the flow rate of the CO₂ gas stream is adjusted to 9,000 SCFM. In some embodiments, the flow rate of the CO₂ gas stream is adjusted to 10,000 SCFM.

In some examples, including any of the foregoing, the manufacturing process includes drying the structural component prior to exposing the structural component to carbon dioxide. In some embodiments, drying the structural component includes reducing free water content to less than 100% (w/w). In some embodiments, the free water content is reduced in a range of about 0% to about 50% (w/w). In some embodiments, drying the structural component is performed at a temperature in a range of about 22° C. to about 85° C. for a time duration in a range of 1 hour (h) to about 24 h.

In some examples, for a given concrete component (e.g., concrete block), the composition of cementitious mixture and manufacturing process are conditioned to fulfill performance requirements (e.g., design strength) in a range of about 700 psi (5 MPa) to about 5000 psi (35 MPa) at 28 days of concrete age (e.g., ≥about 15 MPa as per ASTM C90 for concrete masonry units).

Set forth herein are promising pathways for using hydration reactions and industrial solid waste materials with lime-based or sulfate-based activators. The addition of lime-based activators such as quick lime (CaO), hydrated lime (Ca(OH)₂, or kiln dust in coal combustion residue mixture can promote pozzolanic reactions and thereby result in greater strength gain at early ages. Furthermore, the addition of sulfate activators such as gypsum in coal combustion residue mixture results in ettringite formation that favors microstructure densification and strength gain. Kiln dust such as lime kiln dust (LKD) is a residual by-product material that is generated during the manufacture of lime. During the production of lime, lime kiln dust is carried by hot gasses in a lime kiln and collected by a filter system. The chemical analysis of lime kiln dust from various lime manufacturers varies depending on several factors, including the limestone or dolomitic limestone feed, the type of kiln, the mode of operation of the kiln, the efficiencies of the lime production operation, and the associated filter systems. Lime kiln dust composition generally includes varying amounts of free lime and free magnesium, limestone, and/or dolomitic limestone.

Also set forth herein are promising pathways for using mineral carbonation (i.e., conversion of vapor phase CO₂ into a carbonaceous mineral, e.g., CaCO₃) to sequester CO₂ in alkaline solids used for cementation. Cementation enabled by mineral carbonation is a promising alternative to conventional concrete that relies upon the reaction of CO₂ with alkaline solids to precipitate carbonate minerals. In this method, a shape-stabilized green body (e.g., block, slab, beam) is exposed to a CO₂ gas stream, which may be sourced from CO₂ waste streams. Here, green bodies may be produced by either wet-cast (wherein a mixture is poured into a mold until it hardens and becomes self-supporting) or dry-cast (in which components having very low water contents are mechanically compacted until they are self-supporting). In some examples, the methods herein result in superior strength gain at early and later ages. In some examples, the methods herein use concurrent hydration and carbonation reactions to prepare products which substantially displace portland cement in concrete mixtures. In some examples, the products produced by the methods herein are included in concrete in amounts of about 75% to about 100%. In some examples, herein, the methods produce low-carbon concrete components while valorizing solid waste and CO₂ gas streams.

### Additional Embodiments

In some embodiments, set forth herein is a process of producing a concrete component, comprising: forming, or having formed, a cementitious mixture comprising industrial solid wastes; shaping, or having shaped, the cementitious mixture into a structural component; and exposing, or having exposed, the structural component to CO₂ and H₂O, wherein the cementitious mixture comprises: gypsum, an aluminosilicate material, and an alkaline material; wherein the cementitious mixture has: a sulfate-to-alumina [SO₃/Al₂O₃] ratio by mass of 0.05≤[SO₃/Al₂O₃]≤3; and alkaline material to aluminosilicate ratio by mass of 0.01 to 1. For example, a mixture of 100 g gypsum, 600 g of an aluminosilicate material (e.g., fly ash) comprising 20% Al₂O₃, and 300 g of an alkaline material (e.g., lime kiln dust) gives a sulfate-to-alumina [SO₃/Al₂O₃] ratio by mass of 0.83 [100 g/(600 g*20%)] and alkaline material to aluminosilicate ratio of 0.5 [300 g/600 g].

In some embodiments, set forth herein is a process of producing a concrete component, comprising: forming, or having formed, a cementitious mixture comprising industrial solid wastes; shaping, or having shaped, the cementitious mixture into a structural component; and exposing, or having exposed, the structural component to CO₂ and H₂O; wherein the cementitious mixture comprises: gypsum, an aluminosilicate material, and an alkaline material; wherein the cementitious mixture has: gypsum to aluminosilicate ratio by mass of 0.01 and 0.5; and alkaline material to aluminosilicate ratio by mass of 0.01 to 1. For example, a mixture of 100 g gypsum, 600 g of an aluminosilicate material (e.g., fly ash), and 300 g of an alkaline material (e.g., lime kiln dust) gives gypsum to aluminosilicate ratio by mass of 0.16 [100 g/600 g] and alkaline material to aluminosilicate ratio of 0.5 [300 g/600 g].

In some embodiments, set forth herein is a process of producing a concrete component, including: providing, or having provided, a cementitious mixture including industrial solid wastes; and contacting, or having contacted, the structural component to CO₂ and H₂O; wherein the cementitious mixture includes: gypsum at about 0.5% to about 5% by weight (w/w), an aluminosilicate material and alkaline material; wherein the cementitious mixture has a sulfate-to-alumina [SO₃/Al₂O₃] ratio by mass of 0.05≤[SO₃/Al₂O₃]≤3, gypsum to aluminosilicate ratio by mass of 0.01 and 0.5 and calcium hydroxide to aluminosilicate ratio by mass of 0.01 to 1.

In some embodiments, including any of the foregoing, the process includes using a mixture that is ternary and includes at least gypsum, aluminosilicate material, and alkaline material.

In some embodiments, including any of the foregoing, the alkaline material is lime kiln dust.

In some embodiments, including any of the foregoing, the alkaline material is Ca(OH)₂.

In some embodiments, including any of the foregoing, the process includes shaping, or having shaped, the cementitious mixture into a structural component.

In some embodiments, set forth herein is a process of producing a concrete component, including: forming, or having formed, a cementitious mixture including industrial solid wastes; shaping, or having shaped, the cementitious mixture into a structural component; and exposing, or having exposed, the structural component to CO₂ and H₂O; wherein the cementitious mixture includes: gypsum at about 0.5% to about 5% by weight (w/w), and an aluminosilicate material; wherein the cementitious mixture has a sulfate-to-alumina [SO₃/Al₂O₃] ratio by mass of 0.05≤[SO₃/Al₂O₃]≤3.

In certain embodiments, the sulfate-to-alumina [SO₃/Al₂O₃] ratio by mass is about 0.05. In certain embodiments, the sulfate-to-alumina [SO₃/Al₂O₃] ratio by mass is about 0.1. In certain embodiments, the sulfate-to-alumina [SO₃/Al₂O₃] ratio by mass is about 0.15. In certain embodiments, the sulfate-to-alumina [SO₃/Al₂O₃] ratio by mass is about 0.2. In certain embodiments, the sulfate-to-alumina [SO₃/Al₂O₃] ratio by mass is about 0.25. In certain embodiments, the sulfate-to-alumina [SO₃/Al₂O₃] ratio by mass is about 0.3. In certain embodiments, the sulfate-to-alumina [SO₃/Al₂O₃] ratio by mass is about 0.35. In certain embodiments, the sulfate-to-alumina [SO₃/Al₂O₃] ratio by mass is about 0.4. In certain embodiments, the sulfate-to-alumina [SO₃/Al₂O₃] ratio by mass is about 0.45. In certain embodiments, the sulfate-to-alumina [SO₃/Al₂O₃] ratio by mass is about 0.5. In certain embodiments, the sulfate-to-alumina [SO₃/Al₂O₃] ratio by mass is about 0.55. In certain embodiments, the sulfate-to-alumina [SO₃/Al₂O₃] ratio by mass is about 0.6. In certain embodiments, the sulfate-to-alumina [SO₃/Al₂O₃] ratio by mass is about 0.65. In certain embodiments, the sulfate-to-alumina [SO₃/Al₂O₃] ratio by mass is about 0.7. In certain embodiments, the sulfate-to-alumina [SO₃/Al₂O₃] ratio by mass is about 0.75. In certain embodiments, the sulfate-to-alumina [SO₃/Al₂O₃] ratio by mass is about 0.8. In certain embodiments, the sulfate-to-alumina [SO₃/Al₂O₃] ratio by mass is about 0.85. In certain embodiments, the sulfate-to-alumina [SO₃/Al₂O₃] ratio by mass is about 0.9. In certain embodiments, the sulfate-to-alumina [SO₃/Al₂O₃] ratio by mass is about 0.95. In certain embodiments, the sulfate-to-alumina [SO₃/Al₂O₃] ratio by mass is about 1. In certain embodiments, the sulfate-to-alumina [SO₃/Al₂O₃] ratio by mass is about 1.05. In certain embodiments, the sulfate-to-alumina [SO₃/Al₂O₃] ratio by mass is about 1.1. In certain embodiments, the sulfate-to-alumina [SO₃/Al₂O₃] ratio by mass is about 1.15. In certain embodiments, the sulfate-to-alumina [SO₃/Al₂O₃] ratio by mass is about 1.2. In certain embodiments, the sulfate-to-alumina [SO₃/Al₂O₃] ratio by mass is about 1.25. In certain embodiments, the sulfate-to-alumina [SO₃/Al₂O₃] ratio by mass is about 1.3. In certain embodiments, the sulfate-to-alumina [SO₃/Al₂O₃] ratio by mass is about 1.35. In certain embodiments, the sulfate-to-alumina [SO₃/Al₂O₃] ratio by mass is about 1.4. In certain embodiments, the sulfate-to-alumina [SO₃/Al₂O₃] ratio by mass is about 1.45. In certain embodiments, the sulfate-to-alumina [SO₃/Al₂O₃] ratio by mass is about 1.5. In certain embodiments, the sulfate-to-alumina [SO₃/Al₂O₃] ratio by mass is about 1.55. In certain embodiments, the sulfate-to-alumina [SO₃/Al₂O₃] ratio by mass is about 1.6. In certain embodiments, the sulfate-to-alumina [SO₃/Al₂O₃] ratio by mass is about 1.65. In certain embodiments, the sulfate-to-alumina [SO₃/Al₂O₃] ratio by mass is about 1.7. In certain embodiments, the sulfate-to-alumina [SO₃/Al₂O₃] ratio by mass is about 1.75. In certain embodiments, the sulfate-to-alumina [SO₃/Al₂O₃] ratio by mass is about 1.8. In certain embodiments, the sulfate-to-alumina [SO₃/Al₂O₃] ratio by mass is about 1.85. In certain embodiments, the sulfate-to-alumina [SO₃/Al₂O₃] ratio by mass is about 1.9. In certain embodiments, the sulfate-to-alumina [SO₃/Al₂O₃] ratio by mass is about 1.95. In certain embodiments, the sulfate-to-alumina [SO₃/Al₂O₃] ratio by mass is about 2.05. In certain embodiments, the sulfate-to-alumina [SO₃/Al₂O₃] ratio by mass is about 2.1. In certain embodiments, the sulfate-to-alumina [SO₃/Al₂O₃] ratio by mass is about 2.15. In certain embodiments, the sulfate-to-alumina [SO₃/Al₂O₃] ratio by mass is about 2.2. In certain embodiments, the sulfate-to-alumina [SO₃/Al₂O₃] ratio by mass is about 2.25. In certain embodiments, the sulfate-to-alumina [SO₃/Al₂O₃] ratio by mass is about 2.3. In certain embodiments, the sulfate-to-alumina [SO₃/Al₂O₃] ratio by mass is about 2.35. In certain embodiments, the sulfate-to-alumina [SO₃/Al₂O₃] ratio by mass is about 2.4. In certain embodiments, the sulfate-to-alumina [SO₃/Al₂O₃] ratio by mass is about 2.45. In certain embodiments, the sulfate-to-alumina [SO₃/Al₂O₃] ratio by mass is about 2.5. In certain embodiments, the sulfate-to-alumina [SO₃/Al₂O₃] ratio by mass is about 2.55. In certain embodiments, the sulfate-to-alumina [SO₃/Al₂O₃] ratio by mass is about 2.6. In certain embodiments, the sulfate-to-alumina [SO₃/Al₂O₃] ratio by mass is about 2.65. In certain embodiments, the sulfate-to-alumina [SO₃/Al₂O₃] ratio by mass is about 2.7. In certain embodiments, the sulfate-to-alumina [SO₃/Al₂O₃] ratio by mass is about 2.75. In certain embodiments, the sulfate-to-alumina [SO₃/Al₂O₃] ratio by mass is about 2.8. In certain embodiments, the sulfate-to-alumina [SO₃/Al₂O₃] ratio by mass is about 2.85. In certain embodiments, the sulfate-to-alumina [SO₃/Al₂O₃] ratio by mass is about 2.9. In certain embodiments, the sulfate-to-alumina [SO₃/Al₂O₃] ratio by mass is about 2.95. In some embodiments, the sulfate-to-alumina [SO₃/Al₂O₃] ratio by mass is about 3.

In certain embodiments, the sulfate-to-alumina [SO₃/Al₂O₃] ratio by mass is 0.05. In certain embodiments, the sulfate-to-alumina [SO₃/Al₂O₃] ratio by mass is 0.1. In certain embodiments, the sulfate-to-alumina [SO₃/Al₂O₃] ratio by mass is 0.15. In certain embodiments, the sulfate-to-alumina [SO₃/Al₂O₃] ratio by mass is 0.2. In certain embodiments, the sulfate-to-alumina [SO₃/Al₂O₃] ratio by mass is 0.25. In certain embodiments, the sulfate-to-alumina [SO₃/Al₂O₃] ratio by mass is 0.3. In certain embodiments, the sulfate-to-alumina [SO₃/Al₂O₃] ratio by mass is 0.35. In certain embodiments, the sulfate-to-alumina [SO₃/Al₂O₃] ratio by mass is 0.4. In certain embodiments, the sulfate-to-alumina [SO₃/Al₂O₃] ratio by mass is 0.45. In certain embodiments, the sulfate-to-alumina [SO₃/Al₂O₃] ratio by mass is 0.5. In certain embodiments, the sulfate-to-alumina [SO₃/Al₂O₃] ratio by mass is 0.55. In certain embodiments, the sulfate-to-alumina [SO₃/Al₂O₃] ratio by mass is 0.6. In certain embodiments, the sulfate-to-alumina [SO₃/Al₂O₃] ratio by mass is 0.65. In certain embodiments, the sulfate-to-alumina [SO₃/Al₂O₃] ratio by mass is 0.7. In certain embodiments, the sulfate-to-alumina [SO₃/Al₂O₃] ratio by mass is 0.75. In certain embodiments, the sulfate-to-alumina [SO₃/Al₂O₃] ratio by mass is 0.8. In certain embodiments, the sulfate-to-alumina [SO₃/Al₂O₃] ratio by mass is 0.85. In certain embodiments, the sulfate-to-alumina [SO₃/Al₂O₃] ratio by mass is 0.9. In certain embodiments, the sulfate-to-alumina [SO₃/Al₂O₃] ratio by mass is 0.95. In certain embodiments, the sulfate-to-alumina [SO₃/Al₂O₃] ratio by mass is 1. In certain embodiments, the sulfate-to-alumina [SO₃/Al₂O₃] ratio by mass is 1.05. In certain embodiments, the sulfate-to-alumina [SO₃/Al₂O₃] ratio by mass is 1.1. In certain embodiments, the sulfate-to-alumina [SO₃/Al₂O₃] ratio by mass is 1.15. In certain embodiments, the sulfate-to-alumina [SO₃/Al₂O₃] ratio by mass is 1.2. In certain embodiments, the sulfate-to-alumina [SO₃/Al₂O₃] ratio by mass is 1.25. In certain embodiments, the sulfate-to-alumina [SO₃/Al₂O₃] ratio by mass is 1.3. In certain embodiments, the sulfate-to-alumina [SO₃/Al₂O₃] ratio by mass is 1.35. In certain embodiments, the sulfate-to-alumina [SO₃/Al₂O₃] ratio by mass is 1.4. In certain embodiments, the sulfate-to-alumina [SO₃/Al₂O₃] ratio by mass is 1.45. In certain embodiments, the sulfate-to-alumina [SO₃/Al₂O₃] ratio by mass is 1.5. In certain embodiments, the sulfate-to-alumina [SO₃/Al₂O₃] ratio by mass is 1.55. In certain embodiments, the sulfate-to-alumina [SO₃/Al₂O₃] ratio by mass is 1.6. In certain embodiments, the sulfate-to-alumina [SO₃/Al₂O₃] ratio by mass is 1.65. In certain embodiments, the sulfate-to-alumina [SO₃/Al₂O₃] ratio by mass is 1.7. In certain embodiments, the sulfate-to-alumina [SO₃/Al₂O₃] ratio by mass is 1.75. In certain embodiments, the sulfate-to-alumina [SO₃/Al₂O₃] ratio by mass is 1.8. In certain embodiments, the sulfate-to-alumina [SO₃/Al₂O₃] ratio by mass is 1.85. In certain embodiments, the sulfate-to-alumina [SO₃/Al₂O₃] ratio by mass is 1.9. In certain embodiments, the sulfate-to-alumina [SO₃/Al₂O₃] ratio by mass is 1.95. In certain embodiments, the sulfate-to-alumina [SO₃/Al₂O₃] ratio by mass is 2.05. In certain embodiments, the sulfate-to-alumina [SO₃/Al₂O₃] ratio by mass is 2.1. In certain embodiments, the sulfate-to-alumina [SO₃/Al₂O₃] ratio by mass is 2.15. In certain embodiments, the sulfate-to-alumina [SO₃/Al₂O₃] ratio by mass is 2.2. In certain embodiments, the sulfate-to-alumina [SO₃/Al₂O₃] ratio by mass is 2.25. In certain embodiments, the sulfate-to-alumina [SO₃/Al₂O₃] ratio by mass is 2.3. In certain embodiments, the sulfate-to-alumina [SO₃/Al₂O₃] ratio by mass is 2.35. In certain embodiments, the sulfate-to-alumina [SO₃/Al₂O₃] ratio by mass is 2.4. In certain embodiments, the sulfate-to-alumina [SO₃/Al₂O₃] ratio by mass is 2.45. In certain embodiments, the sulfate-to-alumina [SO₃/Al₂O₃] ratio by mass is 2.5. In certain embodiments, the sulfate-to-alumina [SO₃/Al₂O₃] ratio by mass is 2.55. In certain embodiments, the sulfate-to-alumina [SO₃/Al₂O₃] ratio by mass is 2.6. In certain embodiments, the sulfate-to-alumina [SO₃/Al₂O₃] ratio by mass is 2.65. In certain embodiments, the sulfate-to-alumina [SO₃/Al₂O₃] ratio by mass is 2.7. In certain embodiments, the sulfate-to-alumina [SO₃/Al₂O₃] ratio by mass is 2.75. In certain embodiments, the sulfate-to-alumina [SO₃/Al₂O₃] ratio by mass is 2.8. In certain embodiments, the sulfate-to-alumina [SO₃/Al₂O₃] ratio by mass is 2.85. In certain embodiments, the sulfate-to-alumina [SO₃/Al₂O₃] ratio by mass is 2.9. In certain embodiments, the sulfate-to-alumina [SO₃/Al₂O₃] ratio by mass is 2.95. In some embodiments, the sulfate-to-alumina [SO₃/Al₂O₃] ratio by mass is 3.

In certain embodiments, the alkaline material to aluminosilicate ratio by mass is about 0.01. In certain embodiments, the alkaline material to aluminosilicate ratio by mass is about 0.02. In certain embodiments, the alkaline material to aluminosilicate ratio by mass is about 0.03. In certain embodiments, the alkaline material to aluminosilicate ratio by mass is about 0.04. In certain embodiments, the alkaline material to aluminosilicate ratio by mass is about 0.05. In certain embodiments, the alkaline material to aluminosilicate ratio by mass is about 0.06. In certain embodiments, the alkaline material to aluminosilicate ratio by mass is about 0.07. In certain embodiments, the alkaline material to aluminosilicate ratio by mass is about 0.08. In certain embodiments, the alkaline material to aluminosilicate ratio by mass is about 0.09. In certain embodiments, the alkaline material to aluminosilicate ratio by mass is about 0.1. In certain embodiments, the alkaline material to aluminosilicate ratio by mass is about 0.2. In certain embodiments, the alkaline material to aluminosilicate ratio by mass is about 0.3. In certain embodiments, the alkaline material to aluminosilicate ratio by mass is about 0.4. In certain embodiments, the alkaline material to aluminosilicate ratio by mass is about 0.5. In certain embodiments, the alkaline material to aluminosilicate ratio by mass is about 0.6. In certain embodiments, the alkaline material to aluminosilicate ratio by mass is about 0.7. In certain embodiments, the alkaline material to aluminosilicate ratio by mass is about 0.8. In certain embodiments, the alkaline material to aluminosilicate ratio by mass is about 0.9. In certain embodiments, the alkaline material to aluminosilicate ratio by mass is about 0.1. In certain embodiments, the alkaline material to aluminosilicate ratio by mass is about 0.15. In certain embodiments, the alkaline material to aluminosilicate ratio by mass is about 0.2. In certain embodiments, the alkaline material to aluminosilicate ratio by mass is about 0.25. In certain embodiments, the alkaline material to aluminosilicate ratio by mass is about 0.3. In certain embodiments, the alkaline material to aluminosilicate ratio by mass is about 0.35. In certain embodiments, the alkaline material to aluminosilicate ratio by mass is about 0.4. In certain embodiments, the alkaline material to aluminosilicate ratio by mass is about 0.45. In certain embodiments, the alkaline material to aluminosilicate ratio by mass is about 0.5. In certain embodiments, the alkaline material to aluminosilicate ratio by mass is about 0.55. In certain embodiments, the alkaline material to aluminosilicate ratio by mass is about 0.6. In certain embodiments, the alkaline material to aluminosilicate ratio by mass is about 0.65. In certain embodiments, the alkaline material to aluminosilicate ratio by mass is about 0.7. In certain embodiments, the alkaline material to aluminosilicate ratio by mass is about 0.75. In certain embodiments, the alkaline material to aluminosilicate ratio by mass is about 0.8. In certain embodiments, the alkaline material to aluminosilicate ratio by mass is about 0.85. In certain embodiments, the alkaline material to aluminosilicate ratio by mass is about 0.9. In certain embodiments, the alkaline material to aluminosilicate ratio by mass is about 0.95. In certain embodiments, the alkaline material to aluminosilicate ratio by mass is about 1.

In certain embodiments, the alkaline material to aluminosilicate ratio by mass is 0.01. In certain embodiments, the alkaline material to aluminosilicate ratio by mass is 0.02. In certain embodiments, the alkaline material to aluminosilicate ratio by mass is 0.03. In certain embodiments, the alkaline material to aluminosilicate ratio by mass is 0.04. In certain embodiments, the alkaline material to aluminosilicate ratio by mass is 0.05. In certain embodiments, the alkaline material to aluminosilicate ratio by mass is 0.06. In certain embodiments, the alkaline material to aluminosilicate ratio by mass is 0.07. In certain embodiments, the alkaline material to aluminosilicate ratio by mass is 0.08. In certain embodiments, the alkaline material to aluminosilicate ratio by mass is 0.09. In certain embodiments, the alkaline material to aluminosilicate ratio by mass is 0.1. In certain embodiments, the alkaline material to aluminosilicate ratio by mass is 0.2. In certain embodiments, the alkaline material to aluminosilicate ratio by mass is 0.3. In certain embodiments, the alkaline material to aluminosilicate ratio by mass is 0.4. In certain embodiments, the alkaline material to aluminosilicate ratio by mass is 0.5. In certain embodiments, the alkaline material to aluminosilicate ratio by mass is 0.6. In certain embodiments, the alkaline material to aluminosilicate ratio by mass is 0.7. In certain embodiments, the alkaline material to aluminosilicate ratio by mass is 0.8. In certain embodiments, the alkaline material to aluminosilicate ratio by mass is 0.9. In certain embodiments, the alkaline material to aluminosilicate ratio by mass is 0.1. In certain embodiments, the alkaline material to aluminosilicate ratio by mass is 0.15. In certain embodiments, the alkaline material to aluminosilicate ratio by mass is 0.2. In certain embodiments, the alkaline material to aluminosilicate ratio by mass is 0.25. In certain embodiments, the alkaline material to aluminosilicate ratio by mass is 0.3. In certain embodiments, the alkaline material to aluminosilicate ratio by mass is 0.35. In certain embodiments, the alkaline material to aluminosilicate ratio by mass is 0.4. In certain embodiments, the alkaline material to aluminosilicate ratio by mass is 0.45. In certain embodiments, the alkaline material to aluminosilicate ratio by mass is 0.5. In certain embodiments, the alkaline material to aluminosilicate ratio by mass is 0.55. In certain embodiments, the alkaline material to aluminosilicate ratio by mass is 0.6. In certain embodiments, the alkaline material to aluminosilicate ratio by mass is 0.65. In certain embodiments, the alkaline material to aluminosilicate ratio by mass is 0.7. In certain embodiments, the alkaline material to aluminosilicate ratio by mass is 0.75. In certain embodiments, the alkaline material to aluminosilicate ratio by mass is 0.8. In certain embodiments, the alkaline material to aluminosilicate ratio by mass is 0.85. In certain embodiments, the alkaline material to aluminosilicate ratio by mass is 0.9. In certain embodiments, the alkaline material to aluminosilicate ratio by mass is 0.95. In certain embodiments, the alkaline material to aluminosilicate ratio by mass is 1.

In certain embodiments, the gypsum to aluminosilicate ratio by mass is about 0.01. In certain embodiments, the gypsum to aluminosilicate ratio by mass is about 0.02. In certain embodiments, the gypsum to aluminosilicate ratio by mass is about 0.03. In certain embodiments, the gypsum to aluminosilicate ratio by mass is about 0.04. In certain embodiments, the gypsum to aluminosilicate ratio by mass is about 0.05. In certain embodiments, the gypsum to aluminosilicate ratio by mass is about 0.06. In certain embodiments, the gypsum to aluminosilicate ratio by mass is about 0.07. In certain embodiments, the gypsum to aluminosilicate ratio by mass is about 0.08. In certain embodiments, the gypsum to aluminosilicate ratio by mass is about 0.09. In certain embodiments, the gypsum to aluminosilicate ratio by mass is about 0.1. In certain embodiments, the gypsum to aluminosilicate ratio by mass is about 0.2. In certain embodiments, the gypsum to aluminosilicate ratio by mass is about 0.3. In certain embodiments, the gypsum to aluminosilicate ratio by mass is about 0.4. In certain embodiments, the gypsum to aluminosilicate ratio by mass is about 0.5.

In certain embodiments, the gypsum to aluminosilicate ratio by mass is 0.01. In certain embodiments, the gypsum to aluminosilicate ratio by mass is 0.02. In certain embodiments, the gypsum to aluminosilicate ratio by mass is 0.03. In certain embodiments, the gypsum to aluminosilicate ratio by mass is 0.04. In certain embodiments, the gypsum to aluminosilicate ratio by mass is 0.05. In certain embodiments, the gypsum to aluminosilicate ratio by mass is 0.06. In certain embodiments, the gypsum to aluminosilicate ratio by mass is 0.07. In certain embodiments, the gypsum to aluminosilicate ratio by mass is 0.08. In certain embodiments, the gypsum to aluminosilicate ratio by mass is 0.09. In certain embodiments, the gypsum to aluminosilicate ratio by mass is 0.1. In certain embodiments, the gypsum to aluminosilicate ratio by mass is 0.2. In certain embodiments, the gypsum to aluminosilicate ratio by mass is 0.3. In certain embodiments, the gypsum to aluminosilicate ratio by mass is 0.4. In certain embodiments, the gypsum to aluminosilicate ratio by mass is 0.5.

Herein the “sulfate-to-alumina [SO₃/Al₂O₃] ratio by mass” represents the amount of sulfate in gypsum relative to the amount of alumina in the aluminosilicate material. In some embodiments, the cementitious mixture includes only gypsum and an aluminosilicate material such that the sulfate-to-alumina [SO₃/Al₂O₃] ratio by mass is 0.5 to 3 or any value in between 0.5 to 3. In certain embodiments, the gypsum is natural gypsum. In certain embodiments, the gypsum is synthetic gypsum. In certain embodiments, the aluminosilicate material is LKD. In certain embodiments, the aluminosilicate material is fly ash. In certain embodiments, the aluminosilicate material is an industrial solid waste that does not include calcium silicate.

In some embodiments, including any of the foregoing, the process forms ettringite, calcium carbonate, a carboaluminate phase, or a combination thereof.

In some embodiments, including any of the foregoing, the aluminosilicate material reacts with gypsum to form ettringite.

In some embodiments, including any of the foregoing, the ettringite reacts with CO₂ following carbonation curing to form CaCO₃ and gypsum.

In some embodiments, including any of the foregoing, the gypsum reacts with remaining aluminate phase to form second ettringite following post hydration.

In some embodiments, including any of the foregoing, the cementitious mixture includes alkaline materials.

In some embodiments, including any of the foregoing, the alkaline mineral materials are selected from virgin minerals, mineral residues, and combinations thereof.

In some embodiments, including any of the foregoing, the alkaline mineral materials are mineral residues, and wherein mineral residues are selected from cement kiln dust, lime kiln dust, off-spec limes, sorbent/scrubbing residues, steel slag, iron slag, coal combustion residues, ponded ashes, landfilled ashes, bottom ashes, biomass ashes, fluidized bed combustion ashes, circulating fluidized bed ashes, and combinations thereof.

In some embodiments, including any of the foregoing, the cementitious mixture includes calcium hydroxide.

In some embodiments, including any of the foregoing, the cementitious mixture includes lime kiln dust (LKD).

In some embodiments, including any of the foregoing, the cementitious mixture includes cement kiln dust.

In some embodiments, including any of the foregoing, the cementitious mixture includes fly ash and gypsum.

In some embodiments, including any of the foregoing, the cementitious mixture includes C fly ash and gypsum.

In some embodiments, including any of the foregoing, the cementitious mixture includes F fly ash and gypsum.

In some embodiments, including any of the foregoing, the cementitious mixture includes only fly ash and gypsum.

In some embodiments, including any of the foregoing, the cementitious mixture includes only C fly ash and gypsum.

In some embodiments, including any of the foregoing, the cementitious mixture includes only F fly ash and gypsum.

In some embodiments, including any of the foregoing, the cementitious mixture includes lime kiln dust and gypsum.

In some embodiments, including any of the foregoing, the cementitious mixture includes only lime kiln dust and gypsum.

In some embodiments, including any of the foregoing, the cementitious mixture consists essentially of an aluminosilicate material and gypsum.

In some embodiments, including any of the foregoing, the cementitious mixture consists essentially of fly ash, gypsum, calcium hydroxide, and combinations thereof.

In some embodiments, including any of the foregoing, the cementitious mixture consists of aluminosilicate material and gypsum.

In some embodiments, including any of the foregoing, the cementitious mixture consists of fly ash and gypsum.

In some embodiments, including any of the foregoing, the process forms ettringite post-hydration.

In some embodiments, including any of the foregoing, the cementitious mixture does not include more than 5% w/w calcium silicate.

In some embodiments, including any of the foregoing, the cementitious mixture does not include more than 1% w/w calcium silicate.

In some embodiments, including any of the foregoing, the cementitious mixture includes 1% to 5% w/w calcium silicate.

In some embodiments, including any of the foregoing, the cementitious mixture includes 1% to 4% w/w calcium silicate.

In some embodiments, including any of the foregoing, the cementitious mixture includes 1% to 3% w/w calcium silicate.

In some embodiments, including any of the foregoing, the cementitious mixture includes 1% to 2% w/w calcium silicate.

In some embodiments, including any of the foregoing, the cementitious mixture includes 0.05% to 5% w/w calcium silicate.

In some embodiments, including any of the foregoing, the cementitious mixture includes 0.05% to 4% w/w calcium silicate.

In some embodiments, including any of the foregoing, the cementitious mixture includes 0.05% to 3% w/w calcium silicate.

In some embodiments, including any of the foregoing, the cementitious mixture includes 0.05% to 2% w/w calcium silicate.

In some embodiments, including any of the foregoing, the cementitious mixture does not include calcium silicate.

In some embodiments, including any of the foregoing, the cementitious mixture does not include more than 5% w/w calcium silicate prior to exposing, or having exposed, the structural component to CO₂ and H₂O.

In some embodiments, including any of the foregoing, the cementitious mixture does not include more than 1% w/w calcium silicate prior to exposing, or having exposed, the structural component to CO₂ and H₂O.

In some embodiments, including any of the foregoing, the cementitious mixture does not include calcium silicate prior to exposing, or having exposed, the structural component to CO₂ and H₂O.

In some embodiments, including any of the foregoing, the CO₂ and H₂O are included in a gas stream.

In some embodiments, including any of the foregoing, the CO₂ and H₂O are included in an air stream.

In some embodiments, including any of the foregoing, the CO₂ and H₂O are included in a gas stream that also includes O₂ and N₂.

In some embodiments, including any of the foregoing, the CO₂ and H₂O are included in an air stream wherein the amount of CO₂ is greater than the amount of atmospheric CO₂.

In some embodiments, including any of the foregoing, the cementitious mixture includes calcium aluminate, calcium aluminosilicate, calcium hydroxide, or a combination thereof.

In some embodiments, including any of the foregoing, the cementitious mixture up to 5% w/w by gypsum with the remainder consisting, or consisting essentially of, calcium aluminate, calcium aluminosilicate, calcium hydroxide, or a combination thereof.

In some embodiments, including any of the foregoing, the cementitious mixture further includes industrial solid wastes selected from the group consisting of coal combustion residues, slag, kiln dust, lime, and combinations thereof.

In some embodiments, including any of the foregoing, the cementitious mixture further includes coal combustion residues in a range of about 5% to about 20%, kiln dust in a range of about 1% to about 20%, and lime in a range of about 0.5% to about 10%.

In some embodiments, including any of the foregoing, the coal combustion residues include class C ash or class F fly ash.

In some embodiments, including any of the foregoing, the kiln dust includes lime kiln dust or cement kiln dust.

In some embodiments, including any of the foregoing, the lime includes a member selected from the group consisting of, virgin hydrated lime, hydrated lime residue, lime kiln dust, and combinations thereof.

In some embodiments, including any of the foregoing, the gypsum is selected from natural gypsum or synthetic gypsum (FGD).

In some embodiments, including any of the foregoing, the industrial solid wastes include a member selected from the group consisting of basic oxygen furnace slag, electric arc furnace slag, ladle slag, blast furnace slag, and combinations thereof.

In some embodiments, including any of the foregoing, the cementitious mixture further includes hydraulic cementitious materials selected from portland cement or granulated blast furnace slag.

In some embodiments, including any of the foregoing, the hydraulic cementitious materials are present at about 0% to about 5% (w/w) of the total solid mass of the concrete mixture.

In some embodiments, including any of the foregoing, the hydraulic cementitious material is exclusive of calcium silicate.

In some embodiments, including any of the foregoing, the process includes drying the structural component prior to exposing the structural component to the gas stream to reduce free water content of the structural component to less than 100%.

In some embodiments, including any of the foregoing, the structural component is performed at a temperature in a range of about 22° C. to about 85° C.

In some embodiments, including any of the foregoing, the structural component is performed for a time duration in a range of about 1 hour to about 24 hours.

In some embodiments, including any of the foregoing, the CO₂ gas stream includes about 2-99% (v/v) CO₂.

In some embodiments, including any of the foregoing, the CO₂ gas stream includes about 8-12% (v/v) CO₂.

In some embodiments, including any of the foregoing, the CO₂ gas stream includes greater than or equal to 4-12% (v/v) CO₂.

In some embodiments, including any of the foregoing, the CO₂ gas stream includes greater than or equal to 4-8% (v/v) CO₂.

In some embodiments, including any of the foregoing, the CO₂ gas stream includes greater than or equal to 12% (v/v) CO₂.

In some embodiments, including any of the foregoing, the CO₂ gas stream includes greater than or equal to 8% (v/v) CO₂.

In some embodiments, including any of the foregoing, the CO₂ gas stream includes greater than or equal to 4% (v/v) CO₂.

In some embodiments, including any of the foregoing, the exposing, or having exposed, the structural component to CO₂ and H₂O is performed for a time duration in a range of about 4 hours to about 24 hours.

In some embodiments, including any of the foregoing, the process includes hardening the cementitious mixtures using concurrent hydration and carbonation reactions.

In some embodiments, including any of the foregoing, the process includes hardening the cementitious mixtures using concurrent hydration and carbonation reactions over carbonation curing duration.

In some embodiments, including any of the foregoing, the process includes hardening the cementitious mixtures using hydration reactions after carbonation curing.

In some embodiments, including any of the foregoing, the process includes hardening the cementitious mixtures using hydration reactions after carbonation curing contribute to strength gain of the concrete component.

In some embodiments, including any of the foregoing, the CO₂ gas source is effluent from a member selected from the group consisting of an industrial CO₂-containing gas stream, a dilute flue gas stream, a concentrated CO₂ gas stream, a commercially available CO₂ source post-combustion or post-calcination flue gas streams, a liquefied CO₂, atmospheric CO₂, and combination thereof.

In some embodiments, including any of the foregoing, the CO₂ gas stream passes through a gas-processing unit.

In some embodiments, including any of the foregoing, the process includes process further includes adjusting the temperature, relative humidity, and flow rate of the CO₂ gas stream.

In some embodiments, including any of the foregoing, the process includes adjusting the temperature of the CO₂ gas stream to between, or equal to, about 15° C. to about 100° C.

In some embodiments, including any of the foregoing, the process includes adjusting the temperature of the CO₂ gas stream to between, or equal to, about 20° C. to about 80° C.

In some embodiments, including any of the foregoing, the process includes the temperature of the CO₂ gas stream to between, or equal to, about 30° C. to about 60° C.

In some embodiments, including any of the foregoing, the process includes the temperature of the CO₂ gas stream to between, or equal to, about 35° C. to about 50° C.

In some embodiments, including any of the foregoing, the process includes the relative humidity in the CO₂ gas stream to between, or equal to, about 2% to about 95% (v/v).

In some embodiments, including any of the foregoing, the process includes adjusting the relative humidity in the CO₂ gas stream to between, or equal to, about 10% to about 90% (v/v).

In some embodiments, including any of the foregoing, the process includes adjusting the relative humidity in the CO₂ gas stream to between, or equal to, about 30% to about 80% (v/v).

In some embodiments, including any of the foregoing, the process includes adjusting the CO₂ concentration in the CO₂ gas stream to between, or equal to, about 5% to about 30% (v/v).

In some embodiments, including any of the foregoing, the process includes adjusting the flow rate of the CO₂ gas stream to be about 1 SCFM to about 10000 SCFM.

In some embodiments, including any of the foregoing, the shaping, or having shaped, the cementitious mixture into a structural component includes compacting the cementitious mixture or pouring the cementitious mixture into a mold.

In some embodiments, including any of the foregoing, the cementitious mixture includes pressurizing the cementitious mixture between about 0.5 MPa to about 35 MPa.

In some embodiments, including any of the foregoing, the process includes providing a low-carbon concrete component target compressive strength and adjusting hydration and carbonation reactions via designing concrete mixture formulation (i.e., mixture proportions) and controlling curing process conditions so that the low-carbon concrete component has the target compressive strength.

In some embodiments, including any of the foregoing, the concrete component is low in carbon content.

In some embodiments, including any of the foregoing, the concrete component is low in calcium silicate content.

In some embodiments, set forth herein is a concrete component made by a process herein.

In some embodiments, set forth herein is a concrete including a concrete component herein.

In some embodiments, including any of the foregoing, the concrete includes 0% to about 5% (w/w) Portland cement.

In some embodiments, set forth herein is a shaped green body including industrial solid wastes and cement, wherein the cement includes a cementitious mixture that includes gypsum in a range of about 0.5% to about 5% by weight (w/w).

In some embodiments, set forth herein is a shaped green body including a cementitious mixture of an aluminosilicate material and gypsum, wherein the gypsum is present in a range of about 0.5% to about 5% by weight (w/w).

In some embodiments, including any of the foregoing, the cementitious mixture does not include more than 5% w/w calcium silicate.

In some embodiments, including any of the foregoing, the cementitious mixture does not include more than 1% w/w calcium silicate.

In some embodiments, including any of the foregoing, the cementitious mixture does not include calcium silicate.

In some embodiments, including any of the foregoing, the cementitious mixture includes calcium aluminate, calcium aluminosilicate, calcium hydroxide, or a combination thereof.

In some embodiments, including any of the foregoing, the cementitious mixture includes up to 5% w/w by gypsum with the remainder consisting, or consisting essentially of, calcium aluminate, calcium aluminosilicate, calcium hydroxide, or a combination thereof

In some embodiments, set forth herein is a system for producing low-carbon concrete components, including: means for forming, or having formed, a cementitious mixture including industrial solid wastes; means for shaping, or having shaped, the cementitious mixture into a structural component; and means for exposing, or having exposed, the structural component to CO₂ gas streams; wherein the cementitious mixture includes an aluminosilicate material and gypsum in a range of about 0.5% to about 5% by weight (w/w). The system of claim 74, wherein the cementitious mixture does not include more than 5% w/w calcium silicate.

In some embodiments, including any of the foregoing, the cementitious mixture does not include more than 1% w/w calcium silicate.

In some embodiments, including any of the foregoing, the cementitious mixture does not include calcium silicate.

In some embodiments, including any of the foregoing, the cementitious mixture includes calcium aluminate, calcium aluminosilicate, calcium hydroxide, or a combination thereof.

In some embodiments, including any of the foregoing, the cementitious mixture up to 5% w/w by gypsum with the remainder consisting, or consisting essentially of, calcium aluminate, calcium aluminosilicate, calcium hydroxide, or a combination thereof.

In some embodiments, set forth herein is a cementitious mixture comprising, gypsum at about 0.5% to about 5% by weight (w/w), and an aluminosilicate material; wherein the cementitious mixture has a sulfate-to-alumina [SO₃/Al₂O₃] ratio by mass of 0.05≤[SO₃/Al₂O₃]≤3.

In some embodiments, including any of the foregoing, the cementitious mixture consists, or consists essentially of gypsum at about 0.5% to about 5% by weight (w/w) and an aluminosilicate material.

In some embodiments, including any of the foregoing, the aluminosilicate material is kiln dust, lime kiln dust, or cement kiln dust.

In some embodiments, including any of the foregoing, the cementitious mixture comprises ettringite, calcium carbonate, a carboaluminate phase, or a combination thereof.

In some embodiments, including any of the foregoing, the cementitious mixture comprises fly ash.

In some embodiments, including any of the foregoing, the cementitious mixture comprises calcium aluminate, calcium aluminosilicate, calcium hydroxide, or a combination thereof.

In some embodiments, including any of the foregoing, the cementitious mixture comprises industrial solid wastes selected from the group consisting of coal combustion residues, slag, kiln dust, lime, and combinations thereof.

In some embodiments, including any of the foregoing, the cementitious mixture comprises coal combustion residues selected from class C ash or class F fly ash

In some embodiments, including any of the foregoing, the cementitious mixture comprises lime selected from the group consisting of, virgin hydrated lime, hydrated lime residue, lime kiln dust, and combinations thereof.

### EXAMPLES

### Example 1 (Prophetic)

### Carbonation Characterization and Reactivity of Industrial Solid Wastes

Custom-built flow-through reactors will be used to expose the industrial solid wastes (e.g., coal combustion residues, slag, lime, and kiln dust) in the form of particulates at different temperatures (T), relative humidities (RH), and CO₂ concentrations [CO₂]. The reactors will be housed horizontally in a digitally controlled oven (Quincy Lab, Inc.) for temperature control. The reactor will be instrumented to monitor RH and T. Dry gas mixtures with varying CO₂ concentrations will be prepared by mixing air and CO₂ at prescribed flow rates using mass flow controllers. The dry gas mixtures will be humidified by bubbling the gas through washing bottles containing water and housed in a separate oven, the temperature of which will be controlled to achieve the desired RH within the feed gas stream. The reactants will be exposed to conditions ranging from 0.04% CO₂ (atmospheric) to 100% CO₂ by volume, 35° C. to 80° C., and 0% RH to 99% RH.

Thermogravimetric analysis (TGA; STA 6000, Perkin Elmer) will be used to assess the extent of carbonation experienced by the powder reactants. Around 40 mg of powder will be heated from 35° C. to 975° C. at 15° C./min in an aluminum oxide crucible, under a 20 mL/min ultra-high purity N₂ purge. The CO₂ uptake of reactant will be quantified by assessing the mass loss associated with CaCO₃ decomposition over the temperature range from 550° C. to 900° C., normalized by the mass of the initially dry powder reactant.

The strength activity index of industrial solid wastes will be determined as a measure of their reactivity and cementitious properties.

The particle size, mineralogical compositions, and chemical oxide composition of industrial solid wastes will be determined using static light scattering (SLS), X-ray diffraction (XRD), and X-ray fluorescence (XRF), respectively.

The physical and chemical properties of industrial solid wastes will be correlated to their reactivity and CO₂ uptake potential to establish selection criteria to predict the suitability of industrial solid wastes for use in cementitious mixtures.

### Example 2 (Prophetic)

### Carbonation Behavior and Mechanical Properties of Carbonated Concrete Components Composed of Industrial Solid Wastes

A similar set of carbonation experiments will be conducted on concrete samples comprising industrial solid wastes that are exposed to CO₂ gas stream as described in Example 1 to identify CO₂ uptake potential when the concrete mixture is shaped and formed.

The compressive strengths and durability performance (e.g., water absorption) of concrete mixtures that are composed of industrial solid wastes and exposed to CO₂ streams will be evaluated as a function of time for up to 28 days.

### Example 3 (Prophetic)

### Field Testing of Carbonated Concrete Components Comprising Industrial Solid Wastes at Pilot Scale

A pilot carbonation chamber will be fabricated and set up at a concrete block facility to formulate and produce concrete blocks comprising industrial solid wastes and exposed to simulated CO₂ gas stream.

The performance of carbonated concrete blocks will be evaluated to verify their compliance with industry standards for use in construction applications. The density, water absorption, and compressive strength of carbonated concrete blocks will be measured.

### Example 4 (Empirical)

### Carbonation Characterization of Industrial Solid Wastes to Inform Carbonation Strengthening Potential

This example shows the CO₂ uptake of industrial solid wastes that can translate to carbonation strengthening following exposure to the CO₂ gas stream. This represents the CO₂ uptake potential if these materials are included in a cement mixture.

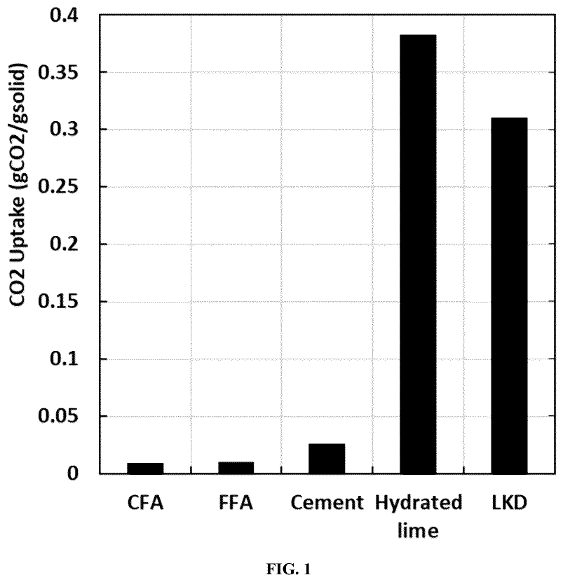

A flow-through reactor was used to expose the industrial solid wastes listed on the x-axis of FIG. 1 in the form of particulates at controlled temperatures (T), relative humidities (RH), and CO₂ concentrations [CO₂]. The reactors were housed horizontally in a digitally controlled oven for temperature control. The reactor was instrumented to monitor RH and T. Dry gas mixtures with varying CO₂ concentrations were prepared by mixing air and CO₂ at prescribed flow rates using mass flow controllers. To control RH, the dry gas mixtures were humidified by bubbling the gas through washing bottles housed in a separate oven, the temperature of which was controlled to achieve the desired RH within the feed gas stream. The reactants (as listed on the x-axis of FIG. 1) were exposed to 8-12% CO₂ by volume, 35° C. to 50° C., 30% RH to 80% RH and flow rates of 1-5 standard liters per minute (slpm). Thermogravimetric analysis (TGA; STA 6000, Perkin Elmer) was used to assess the extent of carbonation experienced by the powder reactants. Around 40 mg of

post-carbonation/hydration powder was heated from 35° C. to 975° C. at 15° C./min in an aluminum oxide crucible and under a 20 mL/min ultra-high purity N₂ purge. The CO₂ uptake of the industrial solid wastes listed on the x-axis was quantified by assessing the mass loss from the post-carbonation/hydration powder that is associated with CaCO₃ decomposition over the temperature range from 550° C. to 900° C., normalized by the mass of the initially dry powder placed in the TGA. FIG. 1 shows the CO₂ uptake of particulates after twenty-four (24) hours of exposure to 12% CO₂ by volume. To provide a point of reference, the CO₂ uptake of virgin hydrated lime is also shown. The results indicate that CO₂ uptake of industrial solid wastes varies between 0.01% and 0.31% by weight of total mass solid.

Without being bound by theory, it is believed that the CO₂ uptake variation is related to the chemical composition of the solids and to the alkaline content of the industrial solid wastes listed on the x-axis of FIG. 1. Specifically, upon contact with water vapor, the reactive crystalline calcium oxide (e.g., CaO) and amorphous compounds present in alkaline solids such as lime kiln dust (LKD) may rapidly dissolve. Alkaline species are released progressively. In the presence of solubilized Ca, and in the presence of dissolved CO₂, mineral carbonates (i.e., calcium carbonate precipitates) precipitate on the surfaces of particles, which induces cementation. The cementation binds proximate particles. This mechanism of carbonation strengthens the concrete. Because of the highly available calcium in lime kiln dust, LKD was observed to have a greater CO₂ uptake than calcium silicate-dominant minerals, such as cement (OPC), were observed to have.

Cement is a calcium-silicate dominant material.

CFA and FFA are class c and class fly ash, respectively and are aluminosilicate dominant materials.

This EXAMPLE 4 shows that LKD as an industrial solid waste and hydrated lime indicated the highest amount of CO₂ uptake. The amount of CO₂ uptake for LKD was much higher than was observed for OPC cement and fly ashes CFA and FFA. The higher CO₂ uptake of the industrial solid waste minerals resulted in a greater carbonation strengthening contribution in concrete mixtures. This shows that addition of LKD in concrete mixtures comprising aluminosilicate and gypsum was surprisingly beneficial for enhancing CO₂ uptake and the resulting carbonation strengthening.

### Example 5

### Carbonation Behavior and Mechanical Properties of Carbonated Concrete Components Composed of Aluminosilicate and Flue Gas Desulfurization Gypsum Minerals

To provide a point of reference, the CO₂ uptake and compressive strength of concrete mixtures comprising cement as calcium silicate-dominant minerals and gypsum are also shown. This example demonstrates the chemical synergy between aluminosilicate and gypsum in a concrete mixture. This synergy between aluminosilicate and gypsum can eliminate the need for calcium silicate-dominant minerals such as ordinary portland cement (OPC) in cement mixtures by providing a preferable alternative.

A similar set of carbonation experiments were conducted on concrete samples that were exposed to the CO₂ gas stream as described in Example 1 to identify CO₂ uptake potential when the concrete mixture is shaped and formed. The compressive strengths of concrete mixtures exposed to CO₂ streams were evaluated. One set of concrete mixtures comprised aluminosilicate-dominant materials and varying dosages of gypsum. Another set of concrete mixtures comprises calcium silicate-dominant minerals and varying dosages of gypsum. This EXAMPLE 5 shows that aluminosilicate-dominant materials (e.g., fly ash) have increasing CO₂ uptake amounts in proportion to the amount of gypsum present. In contrast, this Example also shows that calcium silicate-dominant minerals (e.g., OPC cement) do not show increasing CO₂ uptake amounts in proportion to the amount of gypsum present. This shows a chemical synergy between aluminosilicate and gypsum in a concrete mixture which is not observed for combinations of calcium silicate-dominant materials and gypsum.

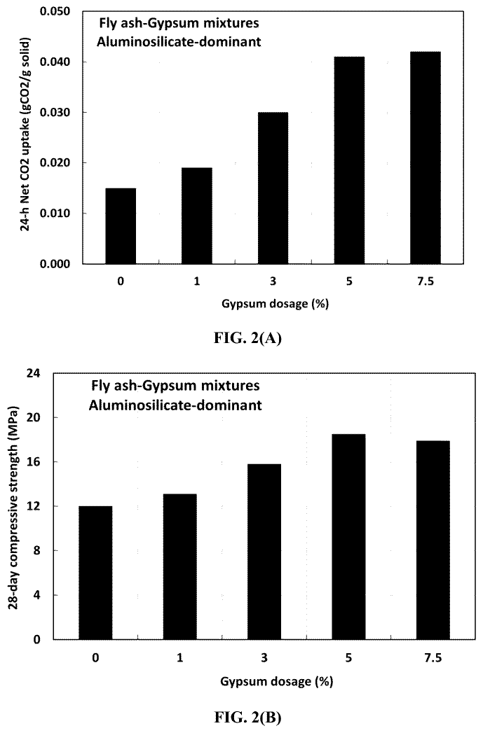

FIG. 2 shows the effect of gypsum addition on CO₂ uptake and compressive strength of concrete mixtures comprising fly ash, which is an aluminosilicate-dominant mineral, with varying amounts of gypsum. The ratio of sulfate from gypsum (SO₃) to alumina in the fly ash (Al₂O₃) ranged from and 0.5 to 3. In other words, 0.5≤[SO₃:Al₂O₃]≤3.

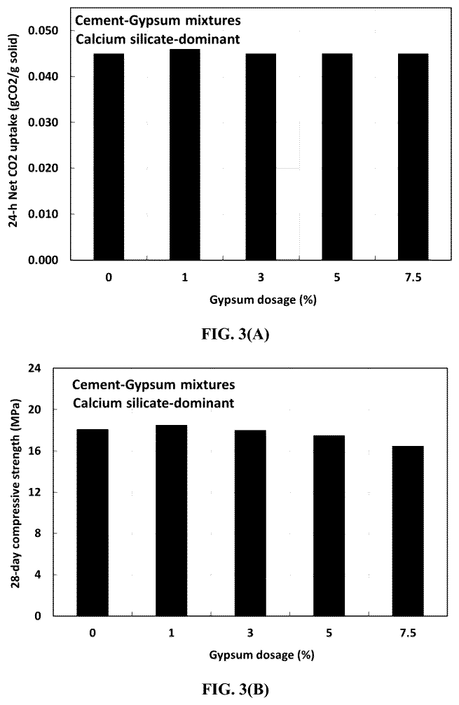

FIG. 3 shows the effect of gypsum addition on CO₂ uptake and compressive strength of concrete mixtures comprising cement, which is a calcium silicate-dominant mineral. The results indicate gypsum addition is beneficial for aluminosilicate-dominant mixtures to enhance CO₂ uptake and improve compressive strength whereas no effect was observed for mixtures comprising gypsum and calcium silicate-dominant (cement) minerals. Without being bound by theory, this results from the chemical reaction between gypsum and aluminosilicate phases that forms ettringite during hydration. Hydration of the aluminosilicate in the presence of gypsum (CSH₂), forms ettringite (C₆AS₃H₃₂, AFt) at early ages, and monosulfoaluminate (C₄ASH₁₂, sulfate-AFm, Ms), at later ages when the sulfate source is depleted. Herein, “Aft” is an abbreviation for ettringite. However, when carbonate ions are present, for example, when provisioned by the dissolution of the CO₂ gas stream during carbonation curing as in this EXAMPLE 5, aluminosilicate materials react with carbonate species to form the CO₃-AFm (i.e., carbonate-AFm) phases. The ettringite can also react with carbonate species to precipitate mineral carbonates (calcium carbonate). In calcium silicate dominant minerals such as OPC cement, the aluminate phase content is low and is regulated by governing cement standards. As a result, gypsum content in cement is also limited and ettringite does not remain stable and typically transforms into monosulfoaluminate (C₄ASH₁₂, sulfate-AFm, Ms). This indicates that when favorable chemistry exists (i.e., combinations of aluminate-rich materials such as LKD and gypsum) the exposure to carbonation and post hydration results in the precipitation of calcium carbonates and ettringite. This, in turn, provides cementitious properties in an ettringite-based binder system.

### Example 6

### Synergy Between Gypsum and Aluminosilicate Materials and Retransformation of Hydration and Carbonation Phases

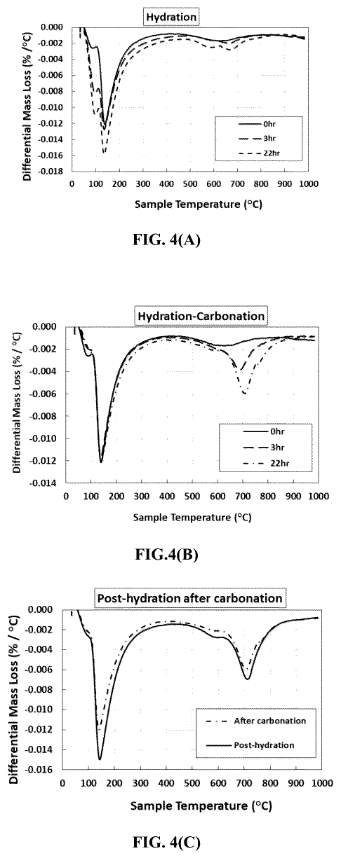

This example shows the effect of gypsum addition on ettringite formation in fly ash, which is an aluminosilicate dominant material, during hydration curing. Following carbonation, the ettringite generated, from the reaction of aluminosilicate and gypsum, reacts with CO₂ and transforms into calcite and gypsum. During post-hydration after carbonation curing, the gypsum can react with the remaining aluminate to re-transform into ettringite. These reactions and resulting microstructural development reduce porosity and improve compressive strength as discussed in EXAMPLE 5, above. FIG. 4 shows the thermogravimetric profiles (TGA) showing the effect of gypsum addition on ettringite and calcium carbonate formation and retransformation of phases as a function of time for aluminosilicate mixtures following (a) hydration curing, (b) carbonation curing, and (c) post hydration after carbonation curing. The numbers in the labels in FIG. 4 indicate the curing time. The results indicate that ettringite content increases during hydration reaction because of gypsum and aluminosilicate mineral reactions. The ettringite can react with the CO₂ gas during carbonation curing. This results in the transformation of ettringite to calcium carbonation and gypsum. Following post-hydration, gypsum can react with the remaining aluminate to form (or form again) ettringite. These synergistic reactions between gypsum and aluminosilicate dominant minerals when exposed to carbonation and post-hydration reaction conditions enhance total solid volume and improve the microstructural development and the compressive strength of concrete. In this example, fly ash is composed of 15% Al₂O₃. With gypsum addition from 1% to 7% by mass in fly ash-gypsum mixtures, the sulfate-to-alumina [SO₃/Al₂O₃] ratio by mass ranged between 0.1 and 0.93.

EXAMPLE 5 and EXAMPLE 6, herein, collectively show that phase formation, transformation, and re-transformation between gypsum and aluminosilicate minerals during carbonation and hydration reactions can be effectively mobilized to design calcium silicate dominant-free concrete formulations (i.e., cement-free). Such design calcium silicate dominant-free concrete formulations would be nearly or completely free of calcium silicate and would use aluminosilicate-based industrial solid wastes with gypsum to form cementitious mixtures.

### Example 7

### Field Testing of Carbonated Concrete Components Comprising Calcium Aluminosilicate Materials Including, but not Limited to, Fly Ash and Lime Kiln Dust, and Flue Gas Desulfurization Gypsum Blended Binder System at Pilot Scale

This field-testing Example demonstrates the chemical synergy between industrial solid wastes and gypsum in a concrete mixture. This synergy can be used to eliminate the need for calcium silicate-dominant minerals such as ordinary portland cement (OPC) in a concrete mixture.

A pilot carbonation chamber was set up at a concrete block facility to formulate and produce concrete blocks comprising industrial solid wastes. The mixture proportions of concrete blocks were composed of 70-80% by mass of aggregates (sand and stone), with the remainder composed of a binder comprising lime kiln dust (calcium-calcium carbonate dominant), fly ash (aluminosilicate-dominant), and gypsum. The sulfate-to-alumina [SO₃/Al₂O₃] ratio by mass ranged between 0.3 and 0.7 and lime kiln dust (alkaline) to aluminosilicate ratio by mass ranged between 0.1 to 0.5. After casting, concrete blocks were exposed to a 12 volume % CO₂ gas stream at T=30-60° C. and RH=20%-80% for early-age carbonation curing for sixteen (16) hours. All the carbonated concrete masonry units produced during field testing were hollow concrete masonry units having nominal dimensions of 8×8×16 inches. (203×203×406 mm) and specified dimensions of 7.625×7.625×15.625 inches (194×194×387 mm). The concrete blocks featured a CO₂ uptake of around 1.5% to 2% by total solid mass and compressive strength ranging from 1200 pounds-per-square-inch (PSI) to 1800 PSI after sixteen (16) hours of carbonation curing. The resulting strength gain is mainly attributed to carbonation strengthening due to mineral carbonate precipitation. Following carbonation curing, the concrete blocks continue to gain strength over time due to continuous hydration and pozzolanic reactions between aluminosilicate from fly ash and any remaining calcium hydroxide from the lime kiln dust. This forms cementitious compounds such as calcium silicate hydrate (C—S—H) or calcium alumina silicate hydrate (C-A-S-H).

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit, and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A process of producing a concrete component, comprising:
forming, or having formed, a cementitious mixture comprising industrial solid wastes;
shaping, or having shaped, the cementitious mixture into a structural component; and
exposing, or having exposed, the structural component to CO₂ and H₂O;
wherein the cementitious mixture comprises:
(a) gypsum,
(b) an aluminosilicate material, and
(c) an alkaline material;
wherein the cementitious mixture has:
a sulfate-to-alumina [SO₃/Al₂O₃] ratio by mass of 0.05≤[SO₃/Al₂O₃]≤3; and
alkaline material to aluminosilicate ratio by mass of 0.01 to 1.

2. A process of producing a concrete component, comprising:
forming, or having formed, a cementitious mixture comprising industrial solid wastes;
shaping, or having shaped, the cementitious mixture into a structural component; and
exposing, or having exposed, the structural component to CO₂ and H₂O;
wherein the cementitious mixture comprises:
(d) gypsum,
(e) an aluminosilicate material, and
(f) an alkaline material;
wherein the cementitious mixture has:
gypsum to aluminosilicate ratio by mass of 0.01 and 0.5; and
and alkaline material to aluminosilicate ratio by mass of 0.01 to 1.

3. The process of claim 1 or 2, wherein the process forms ettringite, calcium carbonate, a carboaluminate phase, or a combination thereof.

4. The process of any one of claims 1-3, wherein the aluminosilicate material reacts with gypsum to form ettringite.

5. The process of any one of claims 1-4, further wherein the ettringite reacts with CO₂ following carbonation curing to form CaCO₃ and gypsum.

6. The process of any one of claims 1-5, wherein the cementitious mixture comprises calcium hydroxide.

7. The process of any one of claims 1-6, wherein the cementitious mixture comprises industrial alkaline materials such as lime kiln dust (LKD).

8. The process of any one of claims 1-7, wherein the cementitious mixture comprises cement kiln dust.

9. The process of any one of claims 1-8, wherein the cementitious mixture comprises fly ash and gypsum.

10. The process of any one of claims 1-9, wherein the cementitious mixture consists essentially of aluminosilicate material and gypsum.

11. The process of any one of claims 1-10, wherein the cementitious mixture consists essentially of fly ash, gypsum, calcium hydroxide, and combinations thereof.

12. The process of any one of claims 1-9, wherein the cementitious mixture consists of aluminosilicate material and gypsum.

13. The process of any one of claims 1-9, wherein the cementitious mixture consists of fly ash and gypsum.

14. The process of any one of claims 1-13, further comprises forming ettringite post-hydration.

15. The process of any one of claims 1-14, wherein the cementitious mixture does not comprise more than 5% w/w calcium silicate.

16. The process of any one of claims 1-15, wherein the cementitious mixture does not comprise more than 1% w/w calcium silicate.

17. The process of any one of claims 1-16, wherein the cementitious mixture does not comprise calcium silicate.

18. The process of any one of claims 1-17, wherein the cementitious mixture does not comprise more than 5% w/w calcium silicate prior to exposing, or having exposed, the structural component to CO₂ and H₂O.

19. The process of any one of claims 1-18, wherein the cementitious mixture does not comprise more than 1% w/w calcium silicate prior to exposing, or having exposed, the structural component to CO₂ and H₂O.

20. The process of any one of claims 1-19, wherein the cementitious mixture does not comprise calcium silicate prior to exposing, or having exposed, the structural component to CO₂ and H₂O.

21. The process of any one of claims 1-20, wherein the cementitious mixture comprises calcium aluminate, calcium aluminosilicate, calcium hydroxide, or a combination thereof.

22. The process of any one of claims 1-21, wherein the cementitious mixture up to 5% w/w by gypsum with the remainder consisting, or consisting essentially of, calcium aluminate, calcium aluminosilicate, calcium hydroxide, or a combination thereof.

23. The process of any one of claims 1-22, wherein the cementitious mixture further comprises industrial solid wastes selected from the group consisting of coal combustion residues, slag, kiln dust, lime, and combinations thereof.

24. The process of any one of claims 1-23, wherein the cementitious mixture further comprises coal combustion residues in a range of about 5% to about 20%, kiln dust in a range of about 1% to about 20%, and lime in a range of about 0.5% to about 10%.

25. The process of any one of claims 1-24, wherein the coal combustion residues comprise class C ash or class F fly ash.

26. The process of any one of claims 23-25, wherein the kiln dust comprises lime kiln dust or cement kiln dust.

27. The process of any one of claims 23-24, wherein the lime comprises a member selected from the group consisting of, virgin hydrated lime, hydrated lime residue, lime kiln dust, and combinations thereof.

28. The process of any one of claims 1-27, wherein the gypsum is selected from natural gypsum or synthetic gypsum (FGD).

29. The process of any one of claims 1-28, wherein the industrial solid wastes comprise a member selected from the group consisting of basic oxygen furnace slag, electric arc furnace slag, ladle slag, blast furnace slag, and combinations thereof.

30. The process of any one of claims 1-29, wherein the cementitious mixture further comprises hydraulic cementitious materials selected from portland cement or granulated blast furnace slag.

31. The process of claim 30, wherein the hydraulic cementitious materials are present at about 0% to about 5% (w/w) of the total solid mass of the concrete mixture.

32. The process of claim 30 or 31, wherein the hydraulic cementitious material is exclusive of calcium silicate.

33. The process of any one of claims 1-32, further comprising drying the structural component prior to exposing the structural component to the gas stream to reduce free water content of the structural component to less than 100%.

34. The process of claim 33, wherein the drying the structural component is performed at a temperature in a range of about 22° C. to about 85° C.

35. The process of claim 33 or 34, wherein the drying the structural component is performed for a time duration in a range of about 1 hour to about 24 hours.

36. The process of any one of claims 1-35, wherein the CO₂ gas stream comprises about 2-99% (v/v) CO₂.

37. The process of any one of claims 1-36, wherein the CO₂ gas stream comprises about 8-12% (v/v) CO₂.

38. The process of any one of claims 1-36, wherein the CO₂ gas stream comprises greater than or equal to 4-12% (v/v) CO₂.

39. The process of any one of claims 1-36 or 38, wherein the CO₂ gas stream comprises greater than or equal to 4-8% (v/v) CO₂.

40. The process of any one of claims 1-39, wherein the CO₂ gas stream comprises greater than or equal to 12% (v/v) CO₂.

41. The process of any one of claims 1-39, wherein the CO₂ gas stream comprises greater than or equal to 8% (v/v) CO₂.

42. The process of any one of claims 1-39, wherein the CO₂ gas stream comprises greater than or equal to 4% (v/v) CO₂.

43. The process of any one of claims 1-42, wherein the exposing, or having exposed, the structural component to CO₂ and H₂O is performed for a time duration in a range of about 4 hours to about 24 hours.

44. The process of any one of claims 1-43, comprising hardening the cementitious mixtures using concurrent hydration and carbonation reactions.

45. The process of any one of claims 1-44, comprising hardening the cementitious mixtures using concurrent hydration and carbonation reactions over carbonation curing duration.

46. The process of any one of claims 1-45, comprising hardening the cementitious mixtures using hydration reactions after carbonation curing.

47. The process of claim 46, wherein the hydration reactions after carbonation curing contribute to strength gain of the concrete component.

48. The process of any one of claims 1-47, wherein the CO₂ gas source is effluent from a member selected from the group consisting of an industrial CO₂-containing gas stream, a dilute flue gas stream, a concentrated CO₂ gas stream, a commercially available CO₂ source post-combustion or post-calcination flue gas streams, a liquefied CO₂, atmospheric CO₂, and combination thereof.

49. The process of any one of claims 1-48, wherein the CO₂ gas stream passes through a gas-processing unit.

50. The process of claim 49, wherein the process further comprises adjusting the temperature, relative humidity, and flow rate of the CO₂ gas stream.

51. The process of any one of claims 1-50, comprising adjusting the temperature of the CO₂ gas stream to between, or equal to, about 15° C. to about 100° C.

52. The process of any one of claims 1-51, comprising adjusting the temperature of the CO₂ gas stream to between, or equal to, about 20° C. to about 80° C.

53. The process of any one of claims 1-52, comprising adjusting the temperature of the CO₂ gas stream to between, or equal to, about 30° C. to about 60° C.

54. The process of any one of claims 1-53, comprising adjusting the temperature of the CO₂ gas stream to between, or equal to, about 35° C. to about 50° C.

55. The process of any one of claims 1-54, comprising adjusting the relative humidity in the CO₂ gas stream to between, or equal to, about 2% to about 95% (v/v).

56. The process of any one of claims 1-55, comprising adjusting the relative humidity in the CO₂ gas stream to between, or equal to, about 10% to about 90% (v/v).

57. The process of any one of claims 1-56, comprising adjusting the relative humidity in the CO₂ gas stream to between, or equal to, about 30% to about 80% (v/v).

58. The process of any one of claims 1-57, comprising adjusting the CO₂ concentration in the CO₂ gas stream to between, or equal to, about 5% to about 30% (v/v).

59. The process of any one of claims 1-58, comprising adjusting the flow rate of the CO₂ gas stream to be about 1 SCFM to about 10000 SCFM.

60. The process of any one of claims 1-59, wherein shaping, or having shaped, the cementitious mixture into a structural component comprises compacting the cementitious mixture or pouring the cementitious mixture into a mold.

61. The process of claim 60, wherein compacting the cementitious mixture comprises pressurizing the cementitious mixture between about 0.5 MPa to about 35 MPa.

62. The process of any one of claims 1-61, comprising providing a low-carbon concrete component target compressive strength and adjusting hydration and carbonation reactions via designing concrete mixture formulation (i.e., mixture proportions) and controlling curing process conditions so that the low-carbon concrete component has the target compressive strength.

63. The process of any one of claims 1-62, wherein the concrete component is low in carbon content.

64. The process of any one of claims 1-62, wherein the concrete component is low in calcium silicate content.

65. A concrete component made by the process of any one of claims 1-64.

66. Concrete comprising the concrete component of claim 65.

67. The concrete of claim 66, wherein the concrete comprises 0% to about 5% (w/w) Portland cement.

68. A shaped green body comprising industrial solid wastes and cement, wherein the cement comprises a cementitious mixture that comprises gypsum in a range of about 0.5% to about 5% by weight (w/w).

69. A shaped green body comprising a cementitious mixture of an aluminosilicate material and gypsum, wherein the gypsum is present in a range of about 0.5% to about 5% by weight (w/w).

70. The shaped green body of claim 68 or 69, wherein the cementitious mixture does not comprise more than 5% w/w calcium silicate.

71. The shaped green body of any one of claims 68-70, wherein the cementitious mixture does not comprise more than 1% w/w calcium silicate.

72. The shaped green body of any one of claims 68-71, wherein the cementitious mixture does not comprise calcium silicate.

73. The shaped green body of any one of claims 68-72, wherein the cementitious mixture comprises calcium aluminate, calcium aluminosilicate, calcium hydroxide, or a combination thereof.

74. The shaped green body of any one of claims 68-73, wherein, wherein the cementitious mixture comprises up to 5% w/w by gypsum with the remainder consisting, or consisting essentially of, calcium aluminate, calcium aluminosilicate, calcium hydroxide, or a combination thereof.

75. A system for producing low-carbon concrete components, comprising:
means for forming, or having formed, a cementitious mixture comprising industrial solid wastes;
means for shaping, or having shaped, the cementitious mixture into a structural component; and
means for exposing, or having exposed, the structural component to CO₂ gas streams; wherein the cementitious mixture comprises an aluminosilicate material and gypsum in a range of about 0.5% to about 5% by weight (w/w).

76. The system of claim 75, wherein the cementitious mixture does not comprise more than 5% w/w calcium silicate.

77. The system of claim 75 or 76, wherein the cementitious mixture does not comprise more than 1% w/w calcium silicate.

78. The system of any one of claims 75-77, wherein the cementitious mixture does not comprise calcium silicate.

79. The system of any one of claims 75-78, wherein the cementitious mixture comprises calcium aluminate, calcium aluminosilicate, calcium hydroxide, or a combination thereof.

80. The system of any one of claims 75-79, wherein, wherein the cementitious mixture up to 5% w/w by gypsum with the remainder consisting, or consisting essentially of, calcium aluminate, calcium aluminosilicate, calcium hydroxide, or a combination thereof.

81. A cementitious mixture comprising, gypsum at about 0.5% to about 5% by weight (w/w), and an aluminosilicate material; wherein the cementitious mixture has a sulfate-to-alumina [SO₃/Al₂O₃] ratio by mass of 0.05≤[SO₃/Al₂O₃]≤3.

82. The cementitious mixture of claim 81, wherein the cementitious mixture consists, or consists essentially of gypsum at about 0.5% to about 5% by weight (w/w) and an aluminosilicate material.

83. The cementitious mixture of claim 82 or 82, wherein the aluminosilicate material is kiln dust, lime kiln dust, or cement kiln dust.

84. The cementitious mixture of any one of claims 81-83, wherein the cementitious mixture comprises ettringite, calcium carbonate, a carboaluminate phase, or a combination thereof.

85. The cementitious mixture of any one of claims 81-84, wherein the cementitious mixture comprises fly ash.

86. The cementitious mixture of any one of claims 81-85, wherein the cementitious mixture comprises calcium aluminate, calcium aluminosilicate, calcium hydroxide, or a combination thereof.

87. The cementitious mixture of any one of claims 81-86, wherein the cementitious mixture comprises industrial solid wastes selected from the group consisting of coal combustion residues, slag, kiln dust, lime, and combinations thereof.

88. The cementitious mixture of any one of claims 81-87, wherein the cementitious mixture comprises coal combustion residues selected from class C ash or class F fly ash.

89. The cementitious mixture of any one of claims 81-88, wherein the cementitious mixture comprises lime selected from the group consisting of, virgin hydrated lime, hydrated lime residue, lime kiln dust, and combinations thereof.

90. The process of any one of claims 1-64, wherein the alkaline and aluminosilicate mineral materials are either virgin or mineral residues or a combination thereof, and wherein mineral residues are selected from cement kiln dust, lime kiln dust, off-spec limes, sorbent/scrubbing residues, steel slag, iron slag, coal combustion residues, ponded ashes, landfilled ashes, bottom ashes, biomass ashes, fluidized bed combustion ashes, circulating fluidized bed ashes, and combinations thereof.
